(19) United States
(12) Patent Application Publication
(10) Pub. No.: US 2026/0181439 A1
(43) Pub. Date: Jun. 25, 2026

(54) SYSTEMS AND METHODS FOR PREDICTIVE TIMING ADVANCE FOR ARTIFICIAL INTELLIGENCE/MACHINE LEARNING BASED MOBILITY ENHANCEMENT

(71) Applicant: APPLE INC., Cupertino, CA (US)

(72) Inventors: Peng Cheng, Beijing (CN); Haijing Hu, Los Gatos, CA (US); Naveen Kumar R Palle Venkata, San Diego, CA (US); Yuqin Chen, Beijing (CN)

(21) Appl. No.: 18/842,672

(22) PCT Filed: Sep. 1, 2023
(86) PCT No.: PCT/CN2023/116494

§ 371 Date: Aug. 29, 2024

(51) Int. Cl. H04W 24/10; H04W 72/23

(52) U.S. Cl. CPC H04W 24/10; H04W 72/23

(57) ABSTRACT

Systems and methods for the use of various artificial intelligence (AI)/machine learning (ML) models with respect to various mobility aspects are described herein. The generation and use of L3 beam-level measurement predictions, L3 cell-level measurement predictions, L1 measurement predictions, network-based timing advance (TA) value predictions, and UE-based TA value predictions using corresponding ML models are discussed. Various examples of the inputs that may be used with respect to these ML models are discussed. The use of various ones of these predictions within mobility contexts including Layer-3 based handover, Layer 1/Layer 2 triggered mobility (LTM), and conditional handover (CHO) are discussed.

### TECHNICAL FIELD

This application relates generally to wireless communication systems, including wireless communication systems capable of performing measurement and/or timing advance (TA) predictions.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems'standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example framework for the use of AI and/or ML in the context of a wireless communication system.

FIG. 2 illustrates an L3 measurement framework that may be used in a wireless communication system, according to embodiments discussed herein.

FIG. 3 illustrates a flow diagram for a UE-sided procedure for L3 measurement prediction as between a UE and a network according to embodiments herein.

FIG. 4 illustrates a flow diagram for a two-sided procedure for L3 measurement prediction as between a UE and a network according to embodiments herein.

FIG. 5A illustrates a first mechanism for making temporal predictions of L3 cell-level measurements, according to embodiments discussed herein.

FIG. 5B illustrates a second mechanism for making temporal predictions of L3 cell-level measurements, according to embodiments discussed herein.

FIG. 5C illustrates a third mechanism for making temporal predictions of L3 cell-level measurements, according to embodiments discussed herein.

FIG. 5D illustrates a fourth mechanism for making temporal predictions of L3 cell-level measurements, according to embodiments discussed herein.

FIG. 6A illustrates a first mechanism for making temporal predictions of L3 beam-level measurements, according to embodiments discussed herein.

FIG. 6B illustrates a second mechanism for making temporal predictions of L3 beam-level measurements, according to embodiments discussed herein.

FIG. 6C illustrates a third mechanism for making temporal predictions of L3 beam-level measurements, according to embodiments discussed herein.

FIG. 7 illustrates a mechanism for making spatial predictions of L3 beam-level measurements, according to embodiments discussed herein.

FIG. 8 illustrates a flow diagram of an LTM procedure between a UE and a base station of a network, according to embodiments discussed herein.

FIG. 9 illustrates a diagram showing the operation of an RSTD-based TA mechanism as between a UE, a source cell, and a target cell, according to embodiments discussed herein.

FIG. 10 illustrates a flow diagram for a UE-sided procedure for L1 and/or TA measurement prediction as between a UE and a network according to embodiments herein.

FIG. 11 illustrates a flow diagram for a two-sided procedure for L1 and/or TA measurement prediction as between a UE and a network according to embodiments herein.

FIG. 12 illustrates a mechanism for making temporal predictions of L1 measurements, according to embodiments discussed herein.

FIG. 13 illustrates a mechanism for making spatial predictions of L1 measurements, according to embodiments discussed herein.

FIG. 14 illustrates a diagram for an example case for various TAs between a UE and each of a first cell, a second cell, and third cell 1408.

FIG. 15 illustrates a mechanism for making temporal predictions of RSTD-based TA measurements, according to embodiments discussed herein.

FIG. 16 illustrates a mechanism for making spatial predictions of RSTD-based TA measurements, according to embodiments discussed herein.

FIG. 17A ad FIG. 17B together illustrate a flow diagram for implementing predictions of early TA in a system including a UE, a source base station communicating with the UE on a serving cell, a first target base station having a first target cell, a second target base station having a second target cell, and a server, according to embodiments discussed herein.

FIG. 18A and FIG. 18B together illustrate a flow diagram for conditional handover that may be used in some wireless communications systems.

FIG. 19 illustrates a flow diagram for a CHO procedure using measurement predictions that uses a UE, a source base station communicating with a UE on a serving cell, a first target base station having a first target cell, a second target base station having a second target cell, and a server, according to embodiments discussed herein.

FIG. 20 illustrates a method of a UE, according to embodiments discussed herein.

FIG. 21 illustrates a method of a RAN, according to embodiments disclosed herein.

FIG. 22 illustrates a method of a UE, according to embodiments discussed herein.

FIG. 23 illustrates a method of a UE, according to embodiments discussed herein.

FIG. 24 illustrates a method of a UE, according to embodiments discussed herein.

FIG. 25 illustrates a method of a RAN, according to embodiments discussed herein.

FIG. 26 illustrates a method of a UE, according to embodiments discussed herein.

FIG. 27 illustrates a method of a UE, according to embodiments discussed herein.

FIG. 28 illustrates a method of a source base station of a RAN, according to embodiments discussed herein FIG. 29 illustrates a method of a UE, according to embodiments discussed herein.

FIG. 30 illustrates a method of a source base station of a RAN, according to embodiments discussed herein.

FIG. 31 illustrates a method of a UE, according to embodiments disclosed herein.

FIG. 32 illustrates an example architecture of a wireless communication system, according to embodiments disclosed herein.

FIG. 33 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Frameworks for Artificial Intelligence/Machine Learning in Wireless Communication Systems

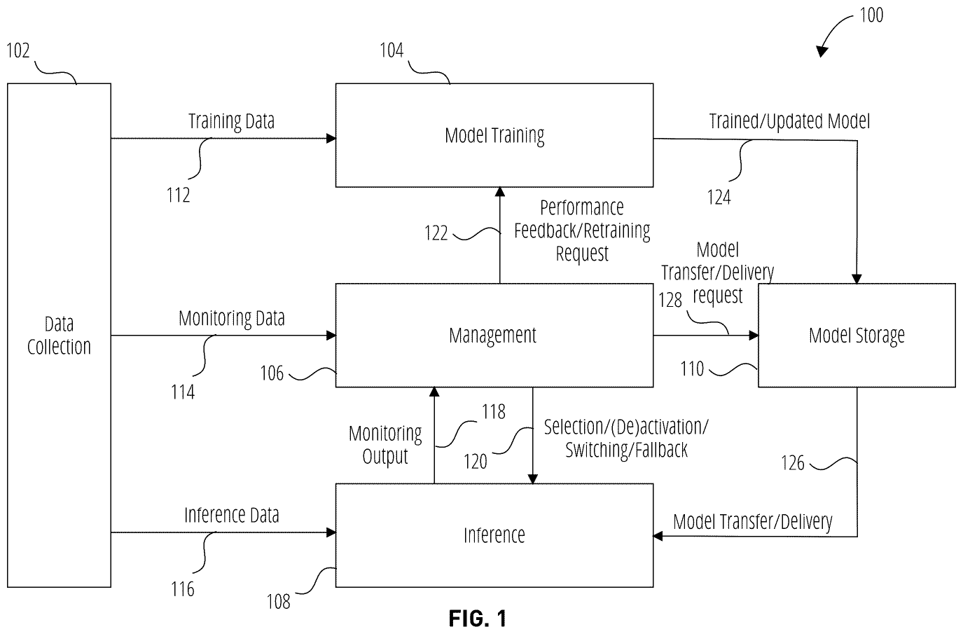

FIG. 1 illustrates an example framework 100 for the use of artificial intelligence (AI) and/or machine learning (ML) in the context of a wireless communication system. Discussion herein relates to the use of an AI/ML model (sometimes referred to as simply a “model” herein).

The framework 100 includes a data collection functionality 102, a model training functionality 104, a management functionality 106, an inference/prediction functionality 108, and a model storage functionality 110.

As illustrated, the data collection functionality 102 may provide training data 112 to the model training functionality 104, may provide monitoring data 114 to the management functionality 106, and/or may provide inference/prediction data 116 to the inference/prediction functionality 108. The model training functionality 104 may provide trained/updated model signaling 124 to the model storage functionality 110. The management functionality 106 may provide performance feedback/retraining request signaling 122 to the model training functionality 104, may provide model transfer/delivery request signaling 128 to the model storage functionality 110, and/or may provide selection/(de)activation/switching/fallback signaling 120 to the inference/prediction functionality 108. The inference/prediction functionality 108 may provide output monitoring signaling 118 to the management functionality 106. The model storage functionality 110 may provide model transfer/delivery signaling 126 to the inference/prediction functionality 108.

In the framework 100, an AI/ML model may be trained at the model training functionality 104 based on training data 112 received from the data collection functionality 102. Once trained, the model may be provided to the model storage functionality 110.

When the model is to be used, it is provided from the model storage functionality 110 to the inference/prediction functionality 108. The data collection functionality 102 may also provide the inference/prediction functionality 108 with inference/prediction data 116 (e.g., input data). The inference/prediction functionality 108 may then make an inference by applying the inference/prediction data 116 to the model. This inference may be reported to a functionality outside the framework 100 for further use.

The management functionality 106 manages the overall operation of the framework 100. Management decisions may be based on monitoring data 114 received at the management functionality 106 from the data collection functionality 102 and/or output monitoring signaling 118 received from the inference/prediction functionality 108. The management functionality 106 may, for example, may provide the model training functionality 104 with training data 112 to inform the model training functionality 104 of the performance of a trained model and/or to request that a present model be retrained. The management functionality 106 may, for example, provide model transfer/delivery request signaling 128 to the model storage functionality 110 to control the transfer to and use of the model at the inference/prediction functionality 108. The management functionality 106 may, for example, control the inference/prediction functionality 108 through selection/(de)activation/switching/fallback signaling 120 to, among other things, indicate a model that is to be used and/or a method of using a present model.

### Use Cases for Artificial Intelligence/Machine Learning in Wireless Communication Systems

With respect to wireless communications systems considerations, various use cases have been identified for the study of useful application of AI/ML models for categories related to physical layer (PHY layer) considerations. One such case is the study of a use of AI/ML models in channel state information (CSI) feedback contexts with the purpose of achieving CSI feedback enhancements. For example, CSI temporal prediction using AI/ML models may be considered.

Another such case relates to beam management considerations. For example, Layer 1 (L1) beam temporal/spatial prediction using AI/ML models may be considered.

Still another such case relates to positioning accuracy enhancements that may be achieved through the use of AI/ML models.

With respect to AI/ML use within a wireless communication system, there are various possible levels of UE/base station collaboration possible. For example, in some cases, it may be that in some cases there is no collaboration between the UE and the base station with respect to the use of an ML model. In other cases, it may be that there is signaling-based collaboration between the UE and the base station, but without a transfer of the ML model as between the base station and the UE (such cases may use, for example, assistance information for ML model selection purposes). In still other cases, it may be that there is signaling-based collaboration between the UE and the base station that includes the transfer of the ML model for use as between the UE and the base station. At least some embodiments discussed herein are applicable to, for example, signaling-based collaboration cases (with or without model transfer).

Proposals for wireless communications systems may relate to the use of AI/ML-enhanced mobility cases. These cases may be divided into various subtopics. For example, a first such subtopic may be with respect to AI/ML-based radio resource management (RRM) prediction, for example the prediction of future L1 and/or Layer 3 (L3) measurement(s) based on historical measurements. In such cases, it may be the intention to reduce UE measurement efforts and/or to reduce a latency for triggering a measurement event.

In another example, another such subtopic may be with respect to AI/ML-based target cell selection, for example with respect to the prediction and notification to the network of which cell and/or beam to which to switch and/or when to make the switch. In such cases, it may be the intention is to allow the UE to not report all its local useful observations with respect to handover to the network, thereby assisting the UE to remain within a given power and/or memory and/or privacy constraint.

In another example, another such subtopic may be with respect to AI/ML-based failure avoidance, for example with respect to a prediction of and notification to the network of a radio link failure (RLF)/handover failure (HOF) that may happen in the future. In such cases, it may be the intention to enable the network to proactively avoid RLF rather than to react only after the RLF occurs (as per some existing passive mechanisms).

Other use cases for the beneficial application of AI/ML include, but are not limited to, AI/ML-based UE trajectory prediction, AI/ML-based discontinuous reception (DRX) adaptation, AI/ML-based slicing/QoE mechanisms, and/or AI/ML-based cell reselection mechanisms.

Accordingly, as can be seen, there are multiple proposals to study AI/ML-based mobility enhancement. Herein, details of various embodiments for such AI/ML-based mobility enhancements are discussed.

It may be that, in some embodiments herein, a UE makes use of an ML model that is trained at a UE based on UE's mobility and mobility related information. In some cases, the UE may notify the network of a prediction of a best target cell and/or beam for a regular HO based on its used of the ML model. In some cases, the UE may notify the network of its prediction on a suggested/rejected candidate cell list for conditional handover (CHO) based on its use of the ML model. In some cases, a UE may be able to predict an imminent RLF and notify the network ahead of time based on its use of the ML model.

### Example L3 Measurement Framework

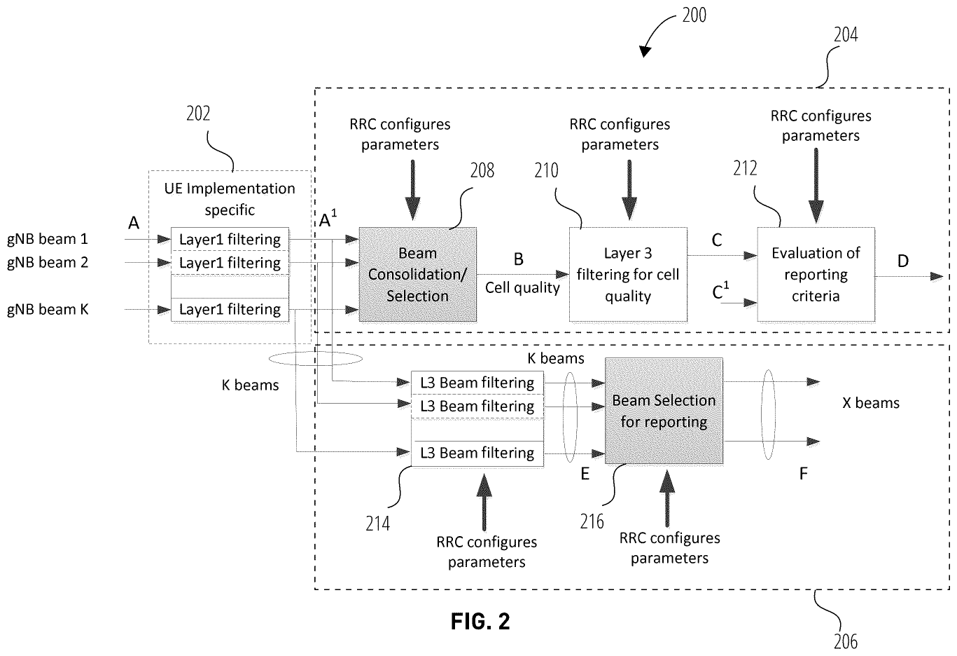

FIG. 2 illustrates an L3 measurement framework 200 that may be used in a wireless communication system, according to embodiments discussed herein. The L3 measurement framework 200 may be, for example a measurement framework used at a UE of an NR wireless communication system.

Preliminarily, results sensed from each of a plurality of monitored gNB (base station) beams undergo L1 beam filters 202. This means that, with respect to a number K of beams, each beam (from 1 to K) may be first treated with an L1 filter. As illustrated, the particular implementation of the L1 filtering may be particular/specific to the UE/the type of the UE/the maker of the UE. Then, as illustrated, the L1 filtered per-beam results enter two different stages: an L3 cell-level measurement stage 204 and an L3 beam-level measurement stage 206.

The L3 cell-level measurement stage 204 is illustrated in the upper right part of FIG. 2. In the L3 cell-level measurement stage 204, the per-beam L1 filtered results are first consolidated 208 by linear averaging into one cell-level value. Then, this cell-level value may be passed to a corresponding L3 filter 210 to generate output. The output may be reported as it passes certain reporting criteria 212 at the UE. As is illustrated, parameters for/used during this procedure may be configured to the UE by the network (e.g., via radio resource control (RRC) configuration).

The L3 beam-level measurement stage 206 is illustrated in the bottom right part of FIG. 2. In the L3 beam-level measurement stage 206, the per-beam L1 filtered results each undergo per-beam L3 beam filters 214, and the UE may then select 216 qualified ones of these beams (e.g., X beams, with X≤K) for output. As is illustrated, parameters for/used during this procedure may be configured to the UE by the network (e.g., via RRC configuration).

In some wireless communication systems, it may be that L3 measurements are configured to occur on a measurement object basis, where the measurement object is per-frequency configured (not per cell configured). Therefore, in such cases, if L3 beam reporting is configured (e.g., in an reportConfigNR information element (IE)), then the UE will apply the same measurement configuration to all cells using that same frequency (e.g., the UE will generate and send L3 beam measurement reports for all cells using that same frequency)—even for such cells having poor cell quality.

Correspondingly, in some wireless communication systems, measurement reports may use a large amount of signaling overhead to effectuate reporting. For example, even in the case of a measurement report for one single neighbor cell, up to 3572 bits overhead may be used, as multiple measurement quantities (e.g., reference signal received power (RSRP)/reference signal received quality (RSRQ)/signal to interference and noise ratio (SINR)) and multiple reference signal types (e.g., synchronization signal block (SSB)/channel state information reference signal (CSI-RS)) may be reported (and note further that up to 64 SSBs/CSI-RSs may be configured for reporting in such cases).

### Overview of Predictions of L3 Cell-Level Measurements and L3 Beam-Level Measurements

Accordingly, embodiments discussed herein may relate to solutions related to the use of predicted L3 cell-level measurements and/or predicted L3 beam-level measurements. Benefits stemming from the use of such L3 measurement predictions may include, for example, an overall reduction in UE measurement reporting efforts corresponding to L3 measurement related cases. For example, the UE may perform L3 measurements for (e.g., only) a number N of top cells. It may then perform predictions (rather than actual measurements) for other cells (and may only return to perform actual L3 measurements of these cells when its prediction is that that cell has entered the top N cells).

Another benefit stemming from the use of L3 measurement predictions may be a reduction in a time to trigger (TTT) for measurement events, which may, for example, correspondingly reduce a HO latency of the UE. This may be achieved by configuring measurement events to trigger based on predicted L3 cell measurements rather than waiting for corresponding actual L3 cell measurements.

Another benefit stemming from the use of L3 measurement predictions may be a reduced use of measurement gaps and/or the use of measurement gaps of relatively reduced durations. The UE may perform L3 measurement predictions with respect to one or more cells (e.g., inter-frequency cells) instead of implementing measurement gapping to enable actual L3 measurements of those cells. This reduced use of measurement gapping may allow the UE to use more channel resources for data transport (this may be particularly useful in cases where the UE has pending data for transport).

Accordingly, embodiments herein discusses various aspects with respect to L3 measurement prediction. A first aspect is that of an overall procedure between the base station and the UE for using L3 measurement predictions. Another such aspect relates to a mechanism for performing inferences of predicted L3 cell measurements. For example, cases for the use of each of a UE-sided model and a two-sided model for performing each of L3 cell-level measurement predictions and L3 beam-level measurement predictions are discussed (note that a network-sided model may have the UE report a local dataset to the network for model training). Yet another such aspect relates to performance monitoring with respect to the results of the ML model at the base station and/or at the UE (and other corresponding lifecycle monitoring (LCM) aspects for the ML model). Further such aspects under discussion include assistance information that may be passed between the UE and the network/base station in these contexts.

### UE-Sided Procedure for L3 Measurement Predictions

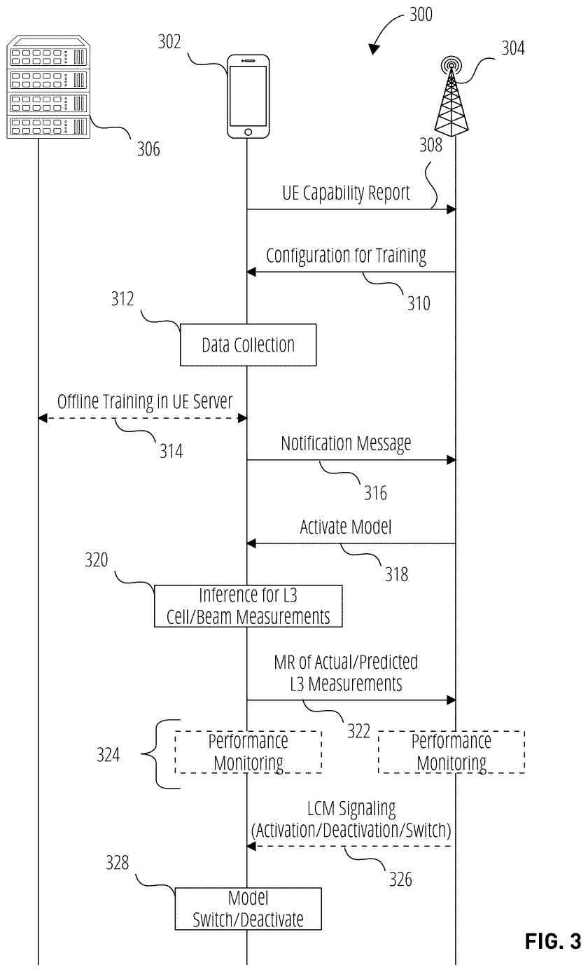

Details with respect to the generation and use of AI/ML-based L3 measurement predictions for mobility enhancement at the UE are accordingly discussed herein. FIG. 3 illustrates a flow diagram 300 for a UE-sided procedure for L3 measurement prediction as between a UE 302 and a network 304 according to embodiments herein. Note that in some embodiments, the UE-sided procedure for L3 measurement prediction may also incorporate the use of a UE server 306, as will be discussed.

The UE-sided procedure for L3 measurement prediction as illustrated in FIG. 3 may correspond to, e.g., cases of L3 cell-level measurement prediction and/or of L3 beam-level measurement prediction.

The flow diagram 300 begins with the generation and transmission of UE capability reporting 308 by the UE 302 to the network 304. In some embodiments, the UE capability reporting 308 may include one or more of: whether the UE supports L3 cell-level temporal measurement predictions; whether the UE supports L3 beam-level temporal measurement predictions; whether the UE supports L3 cell-level spatial measurement predictions; whether the UE supports L3 beam-level spatial measurement predictions; a maximum number of historical samples/slots for one prediction that may be used at/by the UE; a maximum number of predicted samples/slots that may be used at/by the UE; and maximum number of parallel predictions that may be used at/by the UE.

Then, the network 304 provides the UE 302 with a training configuration 310. The training configuration 310 may include one or more of: a ML model type (e.g., a long-short term memory (LSTM) ML model type, a recurrent neural network (RNN) ML model type, etc.) to train, a layer to train, and/or or one or more dedicated ML model(s) to use; a window length corresponding to the history of measurements and/or predictions in temporal and/or spatial domain to use with the ML model; and/or a number of parallel predictions that should be provided by the UE 302.

The UE 302 then performs data collection 312. In some embodiments, this process incorporates the generation/training of the ML model at the UE using the collected data. In some embodiments, the UE provides collected data to the UE server 306 such that offline training 314 (e.g., generation of the ML model) occurs instead at the UE server 306, which then provides the ML model so generated back to the UE 302.

The UE 302 then sends the network 304 a notification message 316. Contents of the notification message 316 may notify the network 304 of which ML model(s) are available at the UE 302 (and, in at least some cases, model identifiers (IDs) corresponding to these ML model(s).

Contents of the notification message 316 may notify the network 304 of a model applicability condition that is usable by the network 304 for purposes of determining which ML model at the UE 302 to use. Note that a model applicability condition may include, for example, use scenario information (e.g., indoor/outdoor), antenna type information, channel type information, UE speed information (e.g., that a UE is travelling less than 5 kilometers per hour (kmph)), UE height information (e.g., corresponding to movement of the UE in elevation), etc.

Note that the notification message 316 be provided, for example, as part of a scheduling request (SR), as part of uplink assistance information (UAI), in a medium access control control element (MAC-CE) or in RRC messaging (e.g., in an RRCReconfigurationComplete message or a newly-provisioned RRC message).

Based on the notification message 316, the network 304 may determine which ML model to activate at the UE 302 and may provide an activation message 318 to the UE 302 that instructs the UE 302 to activate the selected ML model. The activation message 318 may be provided, for example, as part of downlink control information (DCI), a MAC-CE, or RRC messaging.

Note that in alternative embodiments to that illustrated in FIG. 3, it may instead be that the UE 302 may directly notify the network 304 which ML model it prefers to use or will use. In such cases, it may be that the UE 302 determines its preferred/used model based on information like the speed of the UE 302 and/or the channel condition experienced by the UE 302.

The UE 302 then proceeds to perform an inference/prediction 320 for L3 cell-level measurements and/or L3 beam-level measurements (as the case may be) according to the configuration(s) by the network 304 as these are discussed. The inference/prediction 320 may be made based on actual measurements that have been made at the UE.

It may be that the UE 302 is/has been configured (e.g., by the network 304) to trigger a measurement report 322 based on one or more of actual L3 measurements and/or predicted L3 measurements. The measurement report 322 may be sent once the appropriate values for the actual and/or predicted measurements are determined at the UE. The measurement report 322 may report either/both of real and/or predicted L3 cell-level and/or beam-level measurements to the base station (this may occur using, for example, a MeasurementResults message).

It is contemplated that with respect to the UE-sided procedure, either UE 302 or the network 304 may perform performance monitoring 324 of the ML model (e.g., by comparing predicted measurements to corresponding actual measurements). Based on the outcome of the performance monitoring 324, either the UE 302 or the network 304 may initiate LCM signaling 326 for model switching or model deactivation, which then results in a model switch/model deactivation 328 at the UE. In deactivation situations, it may be that the UE 302 and the network 304 then fallback to non-AI/ML-based measurement reporting solutions.

### Two-Sided Procedure for L3 Measurement Predictions

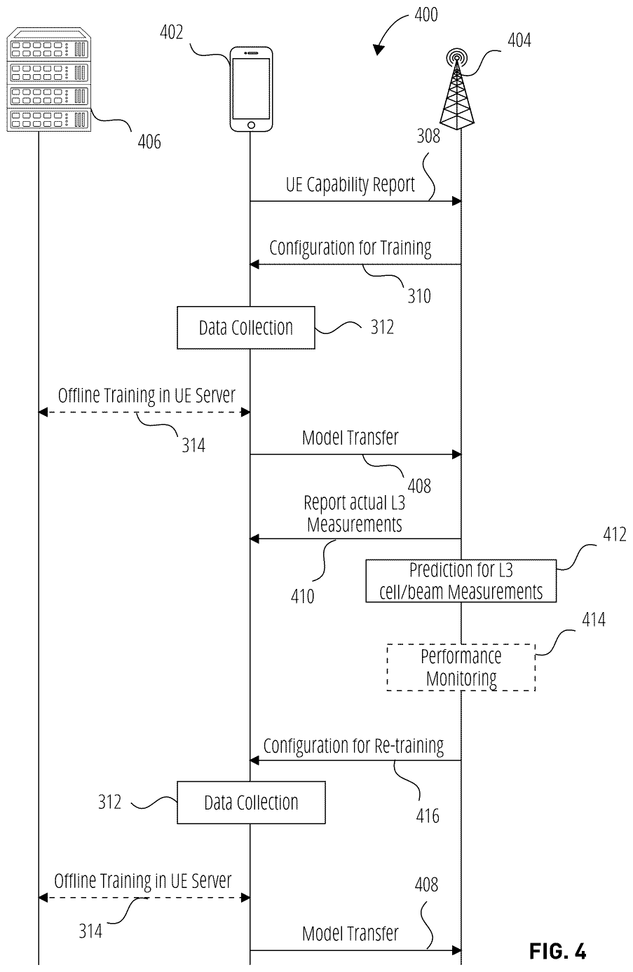

FIG. 4 illustrates a flow diagram 400 for a two-sided procedure for L3 measurement prediction as between a UE 402 and a network 404 according to embodiments herein. Note that in some embodiments, the UE-sided procedure for measurement prediction may also incorporate the use of a UE server 406.

The two-sided procedure for L3 measurement prediction as illustrated in FIG. 3 may correspond to, e.g., cases of L3 cell-level prediction and/or of L3 beam-level prediction.

The UE capability reporting 308, the training configuration 310, the data collection 312, and the offline training 314 may all occur as is described herein in relation to the UE-sided procedure discussed in relation to FIG. 3.

Once the ML model is present at the UE 402, a model transfer 408 occurs during which the UE 402 communicates the ML model to the network 404. The model transfer signaling may be RRC-based or data radio bearer (DRB)-based.

Then, the UE 402 may generate actual L3 cell-level and/or beam-level measurements (for example) and send a measurement report 410 having these actual measurement(s) to the network 404.

The network 404 may then apply these actual measurements with the previously-received ML model in order to perform L3 cell-level and/or L3 beam-level measurement predictions 412 (as the case may be). In some embodiments, the detailed prediction approach may be up to the implementation of the network 404.

It is further contemplated that performance monitoring 414 may occur at the network 404 (e.g., by comparing actual L3 cell-level and/or beam-level measurements received from the UE 402 to the corresponding predicted L3 cell-level and/or beam-level measurements).

The network 404 may further be configured to trigger the performance of ML model re-training based on its implementation (which may base this decision, for example, at least in part on results of the performance monitoring 414). As part of triggering this re-training, the network 404 may provide the UE with re-training configuration 416 that instructs for the re-training (and may provide one or more parameters for the UE to analyze/use as part of the ML model re-training procedure).

In response to the re-training configuration 416, the UE in some embodiments proceeds to again perform data collection 312, offline training 314, and a model transfer 408, as previously described.

### Example Mechanisms for Making L3 Cell-Level Measurement Predictions

In some embodiments, to provide a flexible tradeoff between a UE measurement burden and mobility performance, the UE may be configured (e.g., via RRC signaling) for one of various alternatives of L3 cell-level measurement prediction made by an ML model (which may be referred to as a “measurement prediction model”).

In a first class of embodiments for L3 cell-level measurement prediction, it may be that the L3 cell-level measurement predictions correspond to temporal predictions.

For example, the measurement prediction model may be for the prediction of future L3 cell-level measurements based on present inputs to the measurement prediction model.

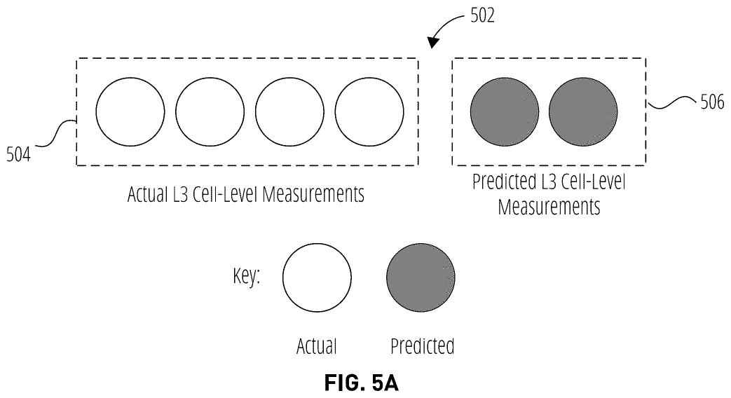

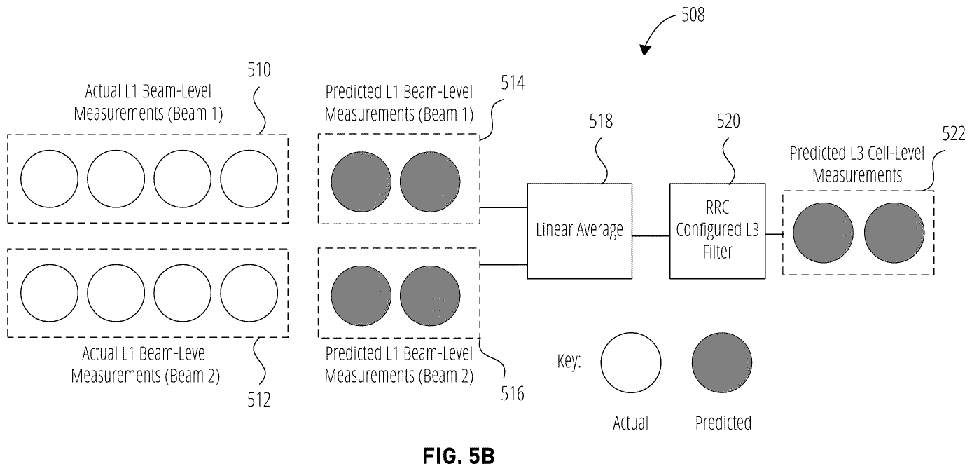

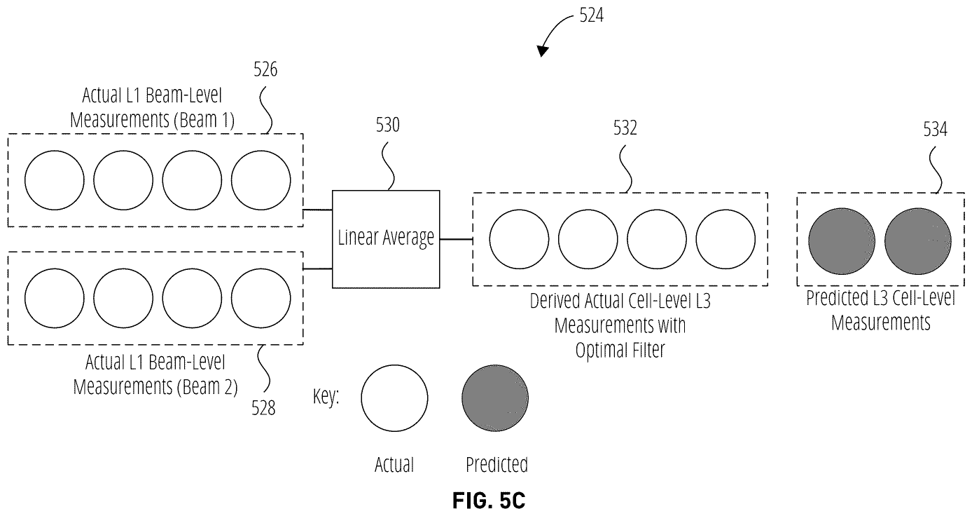

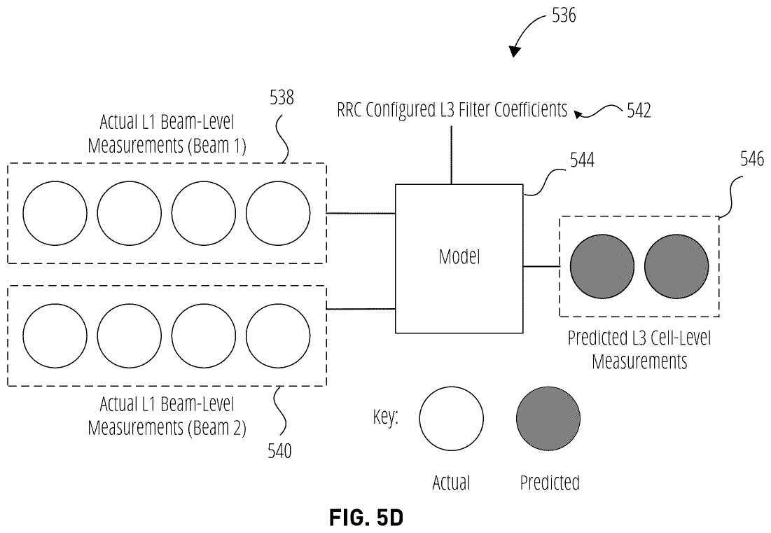

FIG. 5A illustrates a first mechanism 502 for making temporal predictions of L3 cell-level measurements, according to embodiments discussed herein. One or more actual L3 cell-level measurements 504 may be performed at the UE. The measurement prediction model may be configured to receive these one or more actual L3 cell-level measurements 504 as inputs and to provide one or more predicted L3 cell-level measurements 506 in response (where each of the one or more predicted L3 cell-level measurements 506 corresponds to some later time).

FIG. 5B illustrates a second mechanism 508 for making temporal predictions of L3 cell-level measurements, according to embodiments discussed herein. One or more actual L1 beam-level measurements may be taken. In the example of FIG. 5B, the UE takes the first actual L1 beam-level measurements 510 of a first beam and the second actual L1 beam-level measurements 512 of a second beam.

The UE then uses the measurement prediction model to predict one or more predicted L1 beam-level measurements. In the example of FIG. 5B, the UE uses the first actual L1 beam-level measurements 510 and the second actual L1 beam-level measurements 512 with the measurement prediction model to generate the first predicted L1 beam level-measurements 514 and the second predicted L1 beam-level measurements 516.

The UE then performs linear averaging 518 over the one or more predicted beam-level measurements. With respect to the example of FIG. 5A, the UE performs linear averaging over the first predicted L1 beam level-measurements 514 and the second predicted L1 beam-level measurements 516).

L3 filtering 520 is then used on the result of the linear averaging 518 to generate one or more predicted L3 cell-level measurements 522. The L3 filtering 520 may occur according to network configured (e.g., by RRC signaling) L3 filter coefficients, as illustrated. In some embodiments, it may be that the L3 filter coefficients used for the L3 filtering are generated by the measurement prediction model (e.g., based on its receipt of the first actual L1 beam-level measurements 510 and the second actual L1 beam-level measurements 512).

FIG. 5C illustrates a third mechanism 524 for making temporal predictions of L3 cell-level measurements, according to embodiments discussed herein. One or more actual L1 beam-level measurements may be taken. In the example of FIG. 5C, the UE takes the first actual L1 beam-level measurements 526 of a first beam and the second actual L1 beam-level measurements 528 of a second beam.

The UE then performs linear averaging 530 over the one or more actual L1 beam-level measurements. In the example of FIG. 5C, the UE performs the linear averaging 530 over the first actual L1 beam-level measurements 526 and the second actual L1 beam-level measurements 528.

The result of this linear averaging (e.g., the derived actual cell-level L3 measurements 532 in FIG. 5C) and a set of set of configured (e.g., RRC configured) L3 filter coefficients are applied at the measurement prediction model. The measurement prediction model proceeds to use this information to generate the one or more predicted L3 cell-level measurements 534.

In such embodiments, it may be that a dwelling/valid time for the prediction is also calculated by the measurement prediction model and provided as a result along with the one or more predicted L3 cell-level measurements 534.

FIG. 5D illustrates a fourth mechanism 536 for making temporal predictions of L3 cell-level measurements, according to embodiments discussed herein. One or more actual L1 beam-level measurements may be taken. In the example of FIG. 5D, the UE takes one or more first actual L1 beam-level measurements 538 of a first beam and one or more second actual L1 beam-level measurements 540 of a second beam.

The one or more actual L1 beam level measurements (e.g., the one or more first actual L1 beam-level measurements 538 and the one or more second actual L1 beam-level measurements 540) and L3 coefficients 542 (e.g., RRC configured L3 coefficients) are provided to a measurement prediction model 544, which uses these items to generate one or more predicted L3 cell-level measurements 546.

The use of the L3 coefficients 542 in such cases may compensate for the fact that that L1 measurements (such as the one or more first actual L1 beam-level measurements 538 and the one or more second actual L1 beam-level measurements 540) may be less stable than corresponding L3 measurements (and in light of the recognition that in this case the UE is not generating the more stable actual L3 measurements themselves in this case).

In a second class of embodiments for L3 cell-level measurement prediction, the L3 cell-level measurement predictions correspond to spatial predictions. For example, if base station deployment geometry and/or long-term channel temporal statistical info (e.g. correlation) are available, the UE may use a measurement prediction model to infer a neighbor cell's L3 measurement based on a present cell's nearby deployment (e.g., correlation information) and the present cell's L3 cell measurement(s).

Note that configuration information (e.g., RRC configuration information) may be provided to instruct the UE regarding the use of the measurement prediction model to make L3 cell-level measurement predictions. For example, the UE may be configured to generate L3 cell-level measurement predictions with respect to particular cell(s) (e.g., present serving cell(s) and/or neighbor cell(s)).

As another example of using L3 cell-level measurement predictions according to configuration information, the UE may be configured to generate L3 cell-level measurement predictions with respect to particular frequency(s).

As another example of using L3 cell-level measurement predictions according to configuration information the UE may be configured to generate L3 cell-level measurement predictions based on one or more conditions.

In a first example of the use of conditions for using predicted L3 cell-level measurements, the UE may be configured to generate L3 cell-level measurements for up to a number N of cells, where the UE generates actual L3 cell-level measurements for a number of M cells (M<N) known to previously have a strongest RSRP/RSRQ, and further generates predicted L3 cell-level measurements for the remaining N-M cells. In the case that a predicted L3 cell-level measurement falls into the M highest measurements, then the UE will perform actual L3 cell-level measurement of that cell going forward (and the last cell of the prior set of M joins the N-M set for which predictions are instead used).

In a second example of the use of conditions for using predicted L3 cell-level measurements, a configured RSRP/RSRQ/SINR threshold may be compared with an actual or predicted cell L3 measurement. If a cell's actual or predicted L3 cell-level measurement is less than the threshold, the UE performs L3 cell-level prediction for the cell going forward. In a variation of this case, it may be that the base station configures the UE to use separate thresholds with respect to the use of actual L3 cell-level measurements and predicted L3 cell-level measurements.

In a third example of the use of conditions for using predicted L3 cell-level measurements, it may be that L3 cell-level measurement predictions may be performed in cases where interference in the cell is strong. For example, prediction may be used in a case where interference in the cell is greater than a configured interference measurement threshold.

In a fourth example of the use of conditions for using predicted L3 cell-level measurements, L3 cell-level measurement predictions may be performed for all or some indicated inter-frequency measurements.

In a fifth example of the use of conditions for using predicted L3 cell-level measurements, L3 cell-level measurement predictions may be performed if the measurement uses a measurement gap (for example, for measurements for another frequency or another non-overlapping bandwidth part (BWP)).

In a sixth example of the use of conditions for using predicted L3 cell-level measurements, the use of L3 cell-level measurement predictions may depend on a mobility level of the UE. For example, the UE may use L3 cell-level measurement predictions when it is moving at a very low speed.

As another example of using L3 cell-level measurement predictions according to configuration information, the configuration information may indicate neighbor cell(s) and/or frequency(s) for which the UE is allowed to autonomously/independently choose to generate either actual L3 cell-level measurements or predicted L3 cell-level measurements.

As another example of using L3 cell-level measurement predictions according to configuration information, the configuration information may indicate that the UE is to use L3 cell-level measurement predictions for one or more indicated cell(s).

As another example of using L3 cell-level measurement predictions according to configuration information, the configuration information may indicate that the UE is to use L3 cell-level measurement predictions for one or more indicated frequency(s).

### Example Mechanisms for Making L3 Beam-Level Measurement Predictions

In some embodiments, to provide a flexible tradeoff between the UE measurement burden and mobility performance, a UE may be configured (e.g., via RRC signaling) for one of various alternatives of L3 beam-level measurement prediction made by an ML model (which may be referred to as a “measurement prediction model”).

In a first class of embodiments for L3 beam-level measurement prediction, it may be that L3 beam-level measurement predictions correspond to temporal predictions. For example, the measurement prediction model may be for the prediction of future L3 beam-level measurements based on present inputs to the measurement prediction model.

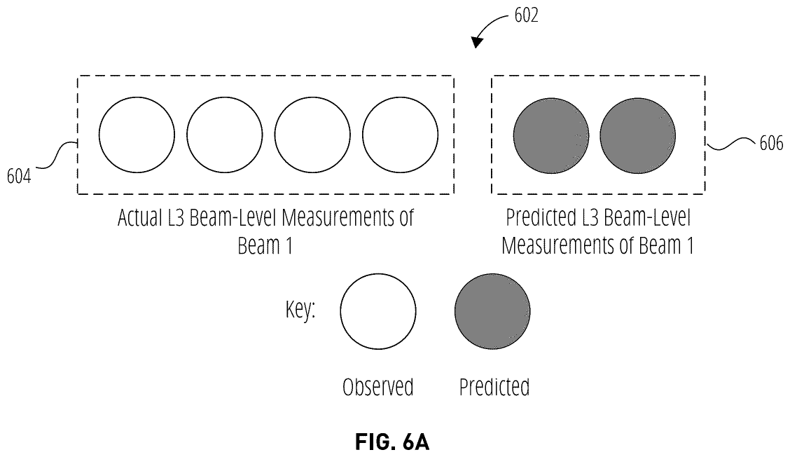

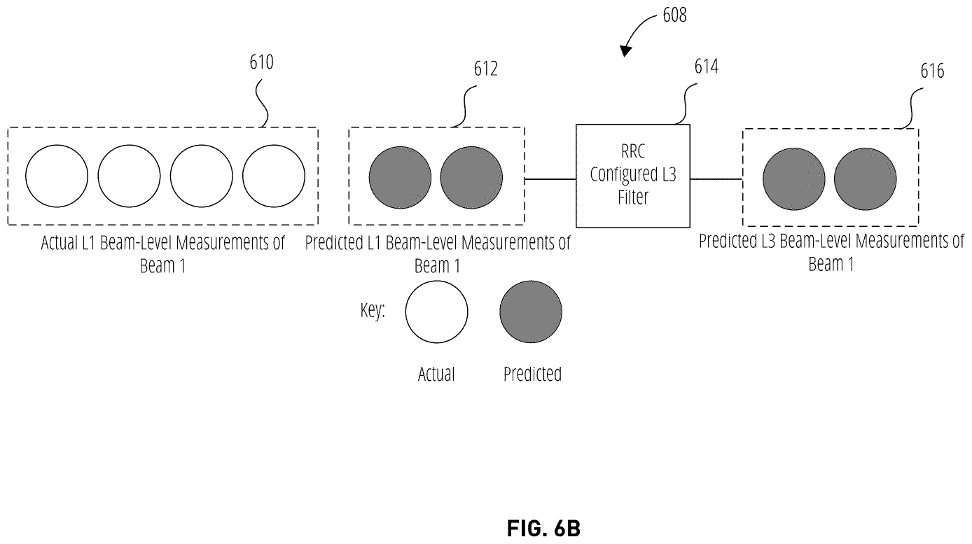

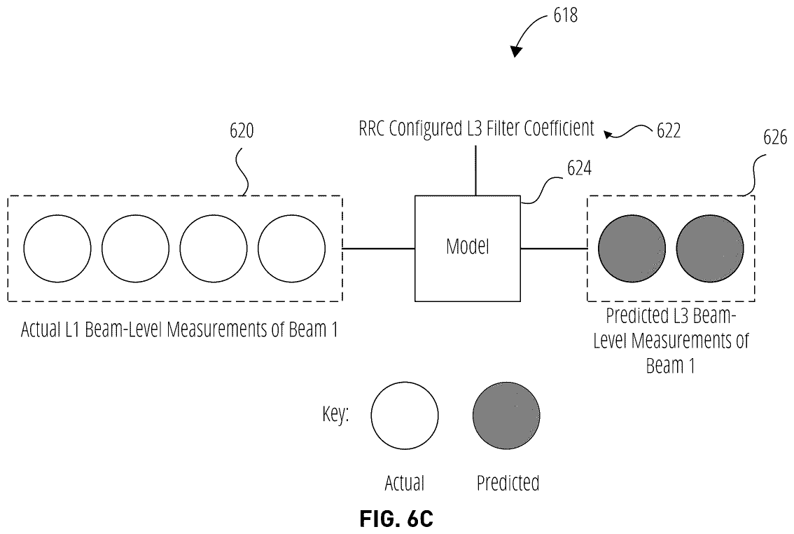

FIG. 6A illustrates a first mechanism 602 for making temporal predictions of L3 beam-level measurements, according to embodiments discussed herein. One or more actual L3 beam-level measurements 604 may be performed at the UE. The measurement prediction model may be configured to receive these one or more actual L3 beam-level measurements 604 and optimized L3 filter coefficients as inputs and to provide one or more predicted L3 beam-level measurements 606 in response (where each of the one or more predicted L3 beam-level measurements 606 corresponds to some later time).

In such embodiments, it may be that a dwelling/valid time for the prediction is also calculated by the measurement prediction model and provided as a result along with the one or more predicted L3 beam-level measurements 606.

FIG. 6B illustrates a second mechanism 608 for making temporal predictions of L3 beam-level measurements, according to embodiments discussed herein. One or more actual L1 beam-level measurement may be taken. In the example of FIG. 6B, the UE takes the actual L1 beam-level measurements 610 of a first beam.

The UE then uses the measurement prediction model to predict one or more predicted L1 beam-level measurements. In the example of FIG. 6B, the UE uses the actual L1 beam-level measurements 610 with the measurement prediction model to generate predicted L1 beam-level measurements 612.

L3 filtering 614 is then used over the one or more predicted L1 beam-level measurements 612 to generate one or more predicted L3 beam-level measurements 616. The L3 filtering 614 may occur according to network configured (e.g., by RRC signaling) L3 filter coefficients, as illustrated.

FIG. 6C illustrates a third mechanism 618 for making temporal predictions of L3 beam-level measurements, according to embodiments discussed herein. One or more actual L1 beam-level measurement may be taken. In the example of FIG. 6C, the UE takes the actual L1 beam-level measurements 620 of a first beam.

The one or more actual L1 beam-level measurements 620 and L3 coefficients 622 (e.g., RRC configured L3 coefficients) are provided to a measurement prediction model 624, which uses these items to generate one or more predicted L3 beam-level measurements 626.

The use of the L3 coefficients 622 in such cases may compensate for the fact that the actual L1 beam-level measurements 620 may be less stable than corresponding L3 measurements (and in light of the recognition that in this case the UE is not generating the more stable actual L3 measurements themselves in this case).

In a second class of embodiments for L3 beam-level measurement prediction, the L3 beam-level measurement predictions correspond to spatial predictions. For example, the UE may predict/infer one beam's (predicted) L3 beam-level measurements based on its neighbor beam(s)′ actual or predicted L3 beam-level measurement(s) using its understanding of applicable spatial channel statistical information.

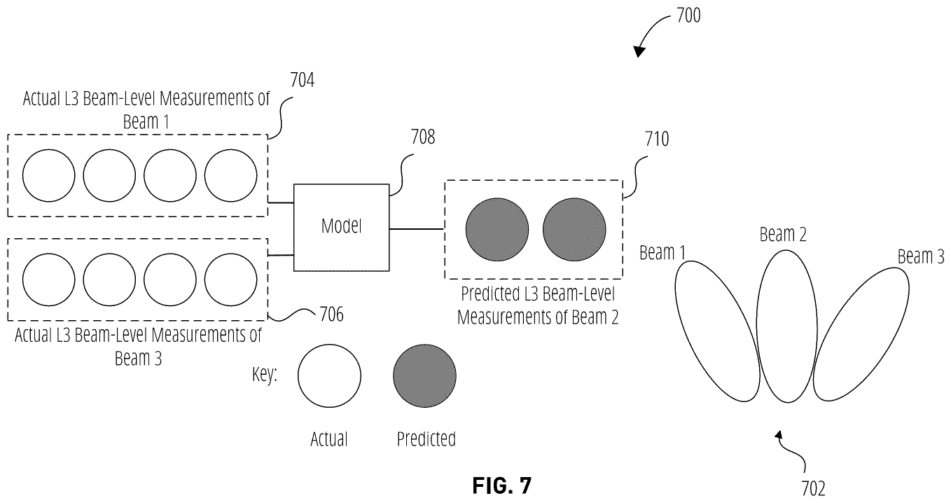

FIG. 7 illustrates a mechanism 700 for making spatial predictions of L3 beam-level measurements, according to embodiments discussed herein. FIG. 7 illustrates a spatial beam arrangement 702 for each of a first beam (“Beam 1”), a second beam (“Beam 2”), and a third beam (“Beam 3”).

One or more actual L3 beam-level measurements may be taken. In the example of FIG. 7, the UE takes one or more first actual L3 beam-level measurements 704 of the first beam (Beam 1) and one or more second actual L3 beam-level measurements 706 of the third beam (Beam 3).

The one or more actual L3 beam level measurements (e.g., the one or more first actual L3 beam-level measurements 704 and the one or more second actual L3 beam-level measurements 706) are provided to a measurement prediction model 708, which uses these items to generate one or more predicted L3 beam-level measurements 710 for the second beam (Beam 2, which is a neighbor beam to Beam 1 and Beam 3 as illustrated). Note that in some embodiments applicable spatial channel statistical information may be used by the measurement prediction model 708 to generate the one or more predicted L3 beam-level measurements 710.

Note that configuration information (e.g., RRC configuration information) may be provided to instruct the UE regarding the use of the measurement prediction model for making L3 beam-level measurement predictions. For example, the UE may be configured to generate L3 beam-level measurement predictions with respect to particular beam(s) of particular cell(s) (e.g., present serving cell(s) and/or neighbor cell(s)).

As another example of using L3 beam-level measurement predictions according to configuration information, the UE may be configured to generate L3 beam-level measurement predictions based on one or more conditions.

In a first example of the use of conditions for using predicted L3 beam-level measurements, the UE may be configured to generate L3 beam-level measurements for up to a number N of beams, where the UE generates actual L3 beams-level measurements for a number of M beams (M<N) known to previously have a strongest RSRP/RSRQ, and further generates predicted L3 beam-level measurements for the remaining N-M beams. In the case that a predicted L3 beam-level measurement falls into the M highest measurements, then the UE will perform actual L3 beam-level measurement of that beam going forward (and the last beam of the prior set of M joins the N-M set for which predictions are instead used).

In a second example of the use of conditions for using predicted L3 beam-level measurements, a configured RSRP/RSRQ/SINR threshold may be compared with an actual or predicted L3 beam-level measurement. If a cell's actual or predicted L3 beam-level measurement is less than the threshold, the UE performs L3 beam-level prediction for the beam. In a variation of this case, it may be that the base station configures the UE to use separate thresholds with respect to the use of actual L3 beam-level measurements and predicted L3 beam-level measurements.

In a third example of the use of conditions for using predicted L3 beam-level measurements, two thresholds may be used. A first configured RSRP threshold may be compared with an actual/predicted L3 cell-level measurement for a cell. If the cell's actual or predicted L3 cell-level measurement is greater than a threshold, the UE may perform L3 beam-level measurement prediction for one or more beams in that cell. Then, a second configured RSRP/RSRQ threshold may be compared with an actual or predicted L3 beam-level measurement for a beam of that cell to determine whether to use actual or predicted L3 beam-level measurement for the beam in the cell going forward.

In variations of this case, it may be that the base station configures the UE to use separate thresholds with respect to the use of actual measurements and predicted measurements.

In a fourth example of the use of conditions for using predicted L3 beam-level measurements, L3 beam-level measurement predictions may be performed for all or some indicated inter-frequency measurements.

In a fifth example of the use of conditions for using predicted L3 beam-level measurements, L3 beam-level measurement predictions may be performed if the measurement uses a measurement gap (for example, for measurements for another frequency or another non-overlapping BWP).

In a sixth example of the use of conditions for using predicted L3 beam-level measurements, the use of L3 beam-level measurement predictions may depend on a mobility level of the UE. For example, the UE may use L3 beam-level measurement predictions when it is moving at a very low speed.

As another example of using L3 beam-level measurement predictions according to configuration information, the configuration information may indicate neighbor cell(s) and/or frequency(s) for which the UE is allowed to autonomously/independently choose to generate either actual L3 beam-level measurements or predicted L3 beam-level measurements.

### Embodiments for Reporting Actual and/or Predicted L3 Measurements

It is contemplated that both periodic and event-triggered L3 measurement reporting may be supported.

In some embodiments, for periodic measurement reporting, the UE may be configured by the network with two periodicities in one reporting configuration. A first of the two periodicities may be a predicted measurement periodicity that indicates how often the UE should perform and/or report AI/ML-based L3 measurement predictions. A second of the two periodicities may be an actual measurement periodicity that indicates how often the UE should perform and/or report actual L3 measurements. In some such embodiments the predicted measurement periodicity may be less than the actual measurement periodicity, such that the UE can use L3 measurement prediction most of time (e.g., to reduce power), while still occasionally reporting actual L3 measurements to provide more accurate updating/information usable for model monitoring.

In some embodiments, for event-triggered reporting, the UE may be configured to use actual and/or predicted L3 measurements to trigger measurement reporting event(s) (e.g. events A 1-A6 as may be understood in a 3GPP NR wireless communication system). In a first case, it may be that only actual L3 cell-level measurements may trigger a measurement reporting event.

In a second case for event-triggered reporting, it may be that either actual or predicted L3 measurements may trigger measurement reporting events. In this second case, the UE may further be configured to trigger a measurement report based on predicted measurement L3 measurement(s) when a confidence level for the predicted measurement(s) are greater than a threshold value.

Whatever the case, once a measurement reporting event is triggered, the UE may report available predicted and/or actual L3 cell-level and/or beam-level measurements as part of the measurement reporting. Within a measurement report, the UE may indicate which cell and/or beam measurements are predictive measurements and/or which cell and/or beam measurements are actual measurements. The UE may further, in at least some embodiments, indicate a reliability probability or confidence level of any predictive measurement(s) in cases where predictive measurement(s) are included in the measurement report.

For both the periodic measurement reporting and event-triggered measurement reporting cases, the UE may first report actual cell and/or beam measurements and then report predicted cell and/or beam measurements in an ordering that first provides measurement quantities from high to low (e.g. RSRP) and then provides a confidence level from high to low (e.g., corresponding to any predictive measurements).

In some embodiments, the total number of parallel predictions may not go beyond a UE's capability. In one such embodiment, a base station implementation may be relied on to choose good condition(s) with respect to a number of parallel predictions. In another such embodiment, the UE may be allowed to drop measurements in an ordering that first drops beam-level measurements, then drops any beam-level and/or cell-level measurements with poor radio conditions, and then drops any predictive beam and/or cell measurements corresponding to a poor confidence level.

### Model Monitoring and LCM for L3 Measurement Predictions

It is contemplated that, with respect to UE-sided procedures for L3 measurement prediction, model monitoring (e.g., monitoring of the performance of the ML model) may be performed at the UE and/or at the base station. In the case that model monitoring is performed at the base station, the procedure may be up to a base station implementation.

In the case that model monitoring is performed at the UE, a model monitoring metric used by the UE may be, in some such embodiments, an error between predicted L3 cell/beam-level measurement(s) and corresponding actual L3 cell/beam-level measurement(s). For example, a mean squared error (MSE) between some predicted L3 cell-level/beam-level measurements and corresponding actual L3 cell-level/beam-level measurement(s) may be used (and note that the use of a MSE metric in this manner may be an example of a “confidence level” as discussed herein). For monitoring purposes, a UE may perform both predicted L3 cell-level/beam-level measurement(s) and corresponding actual L3 cell-level/beam-level measurement(s) for one small set of cell(s) and/or beam(s) (as the case may be).

It is contemplated that the ML model being used may be switched from time to time, (e.g., a different ML model will be selected for use and/or the use of an ML model to make predictions may be paused or stopped). This may occur, for example, based on a result of model monitoring, as will be described. A UE may be configured to perform either a UE-initiated model switch or a network-initiated model switch.

In the case of a UE-initiated switch, the UE may be configured with a condition and UE behaviors regarding a model metric (e.g., a confidence level). For example, the UE may be configured with a MSE with a 0.01 threshold. When the MSE is greater than 0.01, the UE may be configured to fallback to using actual measurement.

In the case of a network-initiated switch, the UE may report the model monitoring metric (e.g., confidence level), and may wait for the base station LCM signaling in response (e.g., an instruction to stop using the ML model and/or to begin the use of a different ML model). The UE may report the model monitoring metric via UAI or a MAC-CE With respect to two-sided procedures for L3 measurement prediction, model monitoring may be performed at the base station side. This monitoring may be according to a base station implementation.

With respect to UE-sided and/or two-sided procedures for L3 measurement prediction that use base station monitoring of the ML model, it may be that the UE may be configured to provide the base station with information to help the base station to perform the monitoring. Such information may include, extra temporal information such as a timestamp(s) for prediction(s), and timestamp(s) of corresponding actual measurement(s). Such information may also/alternatively include extra spatial information such as the UE's actual position, the UE's actual moving orientation, a change to the UE's moving orientation, and/or the a delta (difference in) direction that may be compared with the prediction.

### Assistance Information for L3 Measurement Prediction

Assistance information used with respect to L3 measurement prediction may include assistance information that is sent from the UE to the base station. Further, assistance information used with respect to L3 measurement prediction may also/alternatively include assistance information that is sent from the base station to the UE.

Assistance information sent by the UE to the base station (e.g., to the network) may include, but is not limited to: a predicted optimal L3 filter coefficient; a predicted optimal measurement report event type; a predicted optimal time to trigger (TTT) for a MR event; predicted optimal threshold(s) for a measurement report event; one or more suggested cells for actual measurement; one or more suggested beams for actual measurement; and/or a suggested T304 timer value.

A notification message (e.g., that identifies one or more ML models at the UE to the network) may be used to send the assistance information from the UE to the base station.

Assistance information sent by the base station (e.g., the network) to the UE may include, but is not limited to: information with respect to nearby base station deployment geometry; long-term statistics of temporal correlation; and/or long-term statistics of inter-cell correlation and/or inter-beam correlation.

A downlink (DL) message may be used to send assistance information from the base station to the UE. The message may be a MAC-CE or an RRC message (for example, an RRCReconfigurationComplete message or a new RRC message).

### Embodiments of L1-l2 Triggered Mobility

L1-L2 Triggered Mobility (LTM) procedures may be used in some wireless systems (e.g., such as NR release 18 (Rel-18)). LTM represents a UE mobility mechanism for use in the system that is based on L1 measurements at the UE/L1 measurement reports from the UE (rather than, e.g., L3 measurements at the UE/L3 measurement reports from the UE).

FIG. 8 illustrates a flow diagram 800 of an LTM procedure between a UE 802 and a base station 804 of a network, according to embodiments discussed herein. The LTM procedure represented by the flow diagram 800 anticipates an LTM preparation phase 806, an early synchronization phase 808, an LTM execution phase 810, and an LTM completion phase 812.

The LTM preparation phase 806 contemplates that the UE 802 is in an RRC connected mode 814 and sends a measurement report 816 to the base station 804. Based on the measurement report 816, the base station 804 performs LTM candidate preparation 818 (e.g., the base station 804 selects one or more of the cells from the measurement report 816 to configure as LTM candidates). The base station 804 then sends the UE 802 an RRCReconfiguration message 820 having LTE candidate configuration information (information regarding the one or more LTM candidates selected by the base station 804). The UE 802 responds to the RRCReconfiguration message 820 with an RRCReconfigurationComplete message 822.

Note that an LTM candidate cell configuration can be added, modified and/or released by the network via RRC signaling. Each LTM candidate's cell configuration may be provided as a delta configuration with respect to a reference configuration.

The early synchronization phase 808 of the LTM procedure anticipates that the UE 802 performs DL/UL synchronization 824 with the candidate cells, preparatory to potentially performing mobility to one or more of those candidate cells during the LTM execution phase 810.

The LTM execution phase 810 of the LTM procedure anticipates the use of L1 beam-level measurement(s) (e.g., an RSRP/RSRQ) taken with respect to reference signal(s) (e.g., an SSB or CSI-RS) on those beam(s). The L1 measurement information is provided to the base station 804 by the UE 802 in an L1 measurement report 826. The base station 804 may be configured to make an LTM decision 828 based on the information in the L1 measurement report 826. The LTM decision 828 may be a decision to instruct for the mobility of the UE 802 to candidate cell(s) (as previously configured to the UE 802 in the RRCReconfiguration message 820) based on the information in the L1 measurement report 826. Corresponding to the LTM decision 828, the base station 804 sends a cell switch command 830 to the UE 802 through a MAC-CE that indicates/identifies the selected LTM candidate cell configuration(s) for the selected candidate cell(s).

The UE then detaches 832 from a source cell and applies the identified configuration(s) for the selected candidate/target cell(s). The UE 802 further initiates random access channel (RACH) procedure(s) 834 with these cell(s).

The LTM completion 836 of the LTM completion phase 812 corresponds to the end of the LTM procedure, at which point the UE has accomplished mobility to the indicated candidate cell(s).

An LTM procedure may support candidate target cell timing advance (TA) acquisition via early TA acquisition or RSTD-based TA acquisition. For example, it may be that RACH-less communication between the UE 802 and a candidate cell of the LTM procedure may be allowed/enabled if a TA for the candidate target cell is indicated in the MAC-CE triggering the HO/mobility.

An LTM procedure may further implement failure handling. The UE may start an LTM supervisor timer upon reception of a cell switch command. The UE stops the timer upon a successful completion of the LTM cell switch. If the timer instead expires, the UE considers the LTM cell switch as failed and may initiate an RRC connection re-establishment procedure back to a prior serving cell.

### Embodiments of Timing Advance Acquisition on Target Cell

In some wireless systems, a TA acquisition on a target cell may be achieved via one of various possible TA acquisition mechanisms.

A first possible TA acquisition mechanism is a network-based TA acquisition mechanism. A network-based TA acquisition mechanism may also be referred to herein as an “early TA acquisition mechanism.” Under some such a mechanism, the network estimates TA value(s) for and maintains those TA value(s) at the UE.

Preliminarily, it is noted that the network ensures that a cell transmission time used by the cells of the network are synchronized at the network side. Then, under early TA acquisition mechanisms, a UE sends a preamble to candidate target cell(s) in a contention free random access (CFRA) resource for TA estimation that is known at the network side. Based on the receipt times of these preambles at the various cells (that occur due to different distances between the UE and the various cells), the network determines (and communicates to/maintains at the UE) one or more TAs for the UE to use with respect to corresponding cells.

After sending the preamble, the UE may return to its source cell (for example, there may be no need to receive a random access response (RAR) to the preamble when it is sent for the purposes of enabling a network determination of a network-maintained TA value).

With respect to such network-maintained TA value/early TA acquisition cases, the source cell may indicate to the UE that this early TA acquisition procedure is to be carried out via a physical downlink control channel (PDCCH) order that triggers the UE to perform the RACH/preamble transmission(s) to the target cell(s).

A second possible TA acquisition mechanism is a UE-based TA acquisition mechanism. A UE-based TA acquisition mechanism may also be referred to herein as a “received signal time difference (RSTD)-based TA mechanism”.

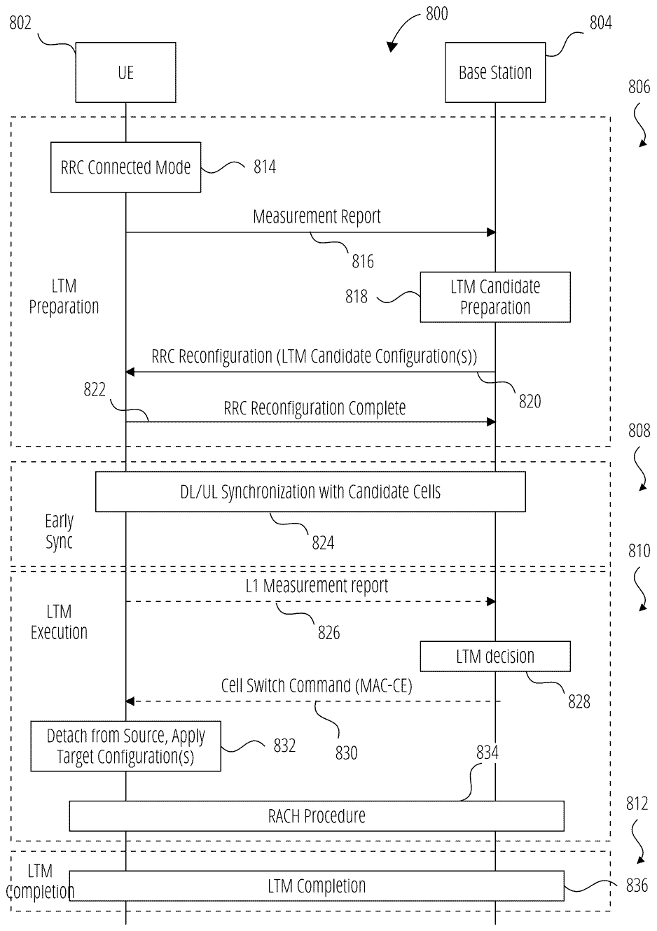

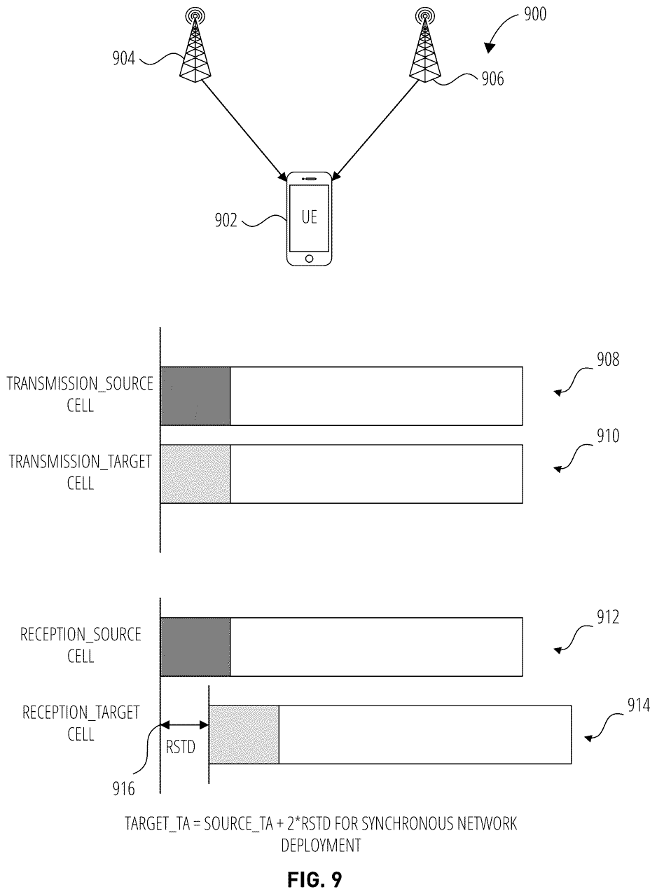

FIG. 9 illustrates a diagram 900 showing the operation of an RSTD-based TA mechanism as between a UE 902, a source cell 904, and a target cell 906, according to embodiments discussed herein. Preliminarily, it is noted that the network ensures that the source cell transmission time 908 and the target cell transmission time 910 are synchronized at the network side, as illustrated. Under the RSTD based TA mechanism, the UE 902 may estimate and maintain a TA for each candidate target cell (such as for the target cell 906), and reports this TA to the network. Within such contexts, it may be that the UE derives a TA for a target cell 906 based on/by considering both an RSTD between a current serving cell and the target serving cell and a known TA value for a current serving cell.

For example, as illustrated in FIG. 9, the UE 902 may determine a RSTD 916 between the source cell reception time 912 for the source cell 904 and the target cell reception time 914 target cell 906. The UE 902 may then multiply the RSTD 916 between the source cell 904 and the target cell 906 by two (to account for both uplink (UL) and DL aspects with respect to TA use). Then, the UE 902 sums this value to the known TA value for the source cell 904 to arrive at the TA value for the target cell 906 (note that in some cases this value may be negative).

### Overview of Predictions of L1 Beam-Level Measurements

Details with respect to the generation and use of AI/ML-based LTM enhancement at the UE are accordingly discussed herein. As has been discussed, an LTM decision may be based on an L1 measurement, which may involve one or more potential considerations. First, an L1 measurement may relatively be less stable than a corresponding L3 measurement. Accordingly, use of the L1 measurement (as compared to an L3 measurement) for mobility may cause frequent cell switching/ping-ponging handovers (HOs) in some circumstances. Accordingly, embodiments herein relate to a UE-sided AI/ML for L1 measurement predictions that use a robust HO decision making process that minimizes the potential for such issues.

Another potential consideration may be that there is an extra burden UE burden to perform L1 measurements and corresponding reporting for multiple candidate cells.

With respect to this issue, some embodiments herein for both UE-sided and network-sided L1 measurement predictions are configured to reduce (relatively) the UE burden for L1 measurement and reporting. For example, in some embodiments there may be more resources reserved in candidate LTM cells.

Further, with respect to extra UE effort in L1 mobility cases, it may be that for TA acquisition for each candidate cell, in cases of the use of a network-based/early TA acquisition mechanism, the UE may send a preamble to one or more target cells as discussed. Further, in cases of UE-based/RSTD-based TA acquisition mechanism, measurement(s) for and calculation(s) of the TA(s) for the target cell(s) may need to be performed and be reported to the network.

Accordingly, embodiments herein discuss various aspects with respect to L1 measurement prediction and/or TA prediction. A first aspect is that of an overall procedure between a base station and a UE for using L1 measurement and/or TA prediction. Another such aspect relates to procedures for training an ML model to be used for L1 and/or TA predictions. Another such aspect relates to a mechanism for performing an inference of L1 measurement predictions and/or RSTD-based mechanism TA predictions. For example, cases for the use of each of a UE-sided model and a two-sided model for each of L1 measurement predictions and/or RSTD-based mechanism TA predictions are discussed (and these predictions may be spatial predictions and/or temporal predictions, as is discussed in more detail elsewhere). Further, cases for the use of a network-sided model and the performance of an inference for early TA acquisition mechanism TA predictions are discussed. In such cases, a joint temporal-spatial prediction may be generated. Further aspects include performance monitoring that may occur.

### UE-Sided Procedure for L1 Measurement And/or TA Measurement Predictions

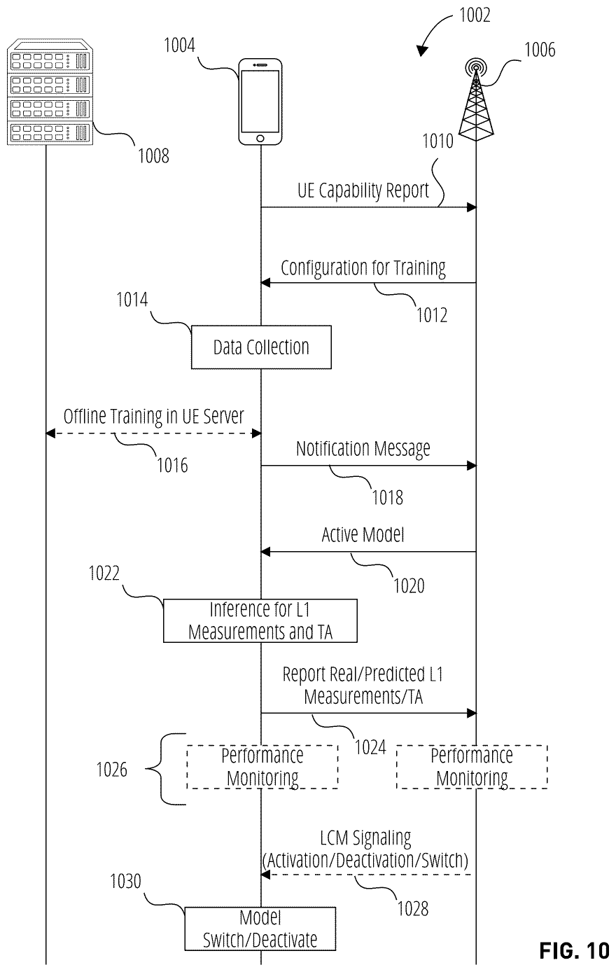

Details with respect to the generation and use of AI/ML-based L1 and/or TA measurement predictions for mobility enhancement at the UE are accordingly discussed herein. FIG. 10 illustrates a flow diagram 1002 for a UE-sided procedure for L1 and/or TA measurement prediction as between a UE 1004 and a network 1006 according to embodiments herein. Note that in some embodiments, the UE-sided procedure for L1 and/or TA measurement prediction may also incorporate the use of a UE server 1008.

The flow diagram 1002 begins with the generation and transmission of UE capability reporting 1010 by the UE 1004 to the network 1006. In some embodiments the UE capability reporting 1010 may include one or more of: whether the UE supports L1 temporal measurement predictions; whether the UE supports L1 spatial measurement predictions; whether the UE supports RSTD-based TA predictions in the time domain; whether the UE supports RS RSTD based-TA prediction in the spatial domain; a maximum number of historical samples/slots that may be used at the UE; a maximum number of predicted samples/slots that may be used at the UE; and/or a maximum number of parallel predictions that may be used at the UE.

Then, the network 1006 provides the UE 1004 with a training configuration 1012. The training configuration 1012 may include one or more of: a ML model type (e.g., a long-short term memory (LSTM) ML model type, a recurrent neural network (RNN) ML model type, etc.) to train, a layer to train, and/or or one or more dedicated ML model(s) to use; a window length corresponding to the history of measurements and/or predictions in temporal and/or spatial domain to use with the ML model; and/or a maximum number of parallel predictions that should be provided by the UE 1004.

The UE 1004 then performs data collection 1014. In some embodiments, this process incorporates the generation/training of the ML model at the UE 1004 using the collected data. In some embodiments, the UE 1004 provides collected data to the UE server 1008 such that offline training 1016 (e.g., generation of the ML model) occurs instead at the UE server 1008, which then provided the ML model so generated back to the UE 1004.

The UE 1004 then sends the network 1006 a notification message 1018.

Contents of the notification message 1018 may notify the network 1006 of which ML model(s) are available at the UE 1004 (and, in at least some cases, model IDs corresponding to these ML model(s).

Contents of the notification message 1018 may notify the network 1006 of a model applicability condition that is usable by the network 1006 for purposes of determining which ML model at the UE 1004 to use. Note that a model applicability condition may include, for example, use scenario information (e.g., indoor/outdoor), antenna type information, channel type information, UE speed information (e.g., that a UE is travelling less than 5 kilometers per hour (kmph)), UE height information (e.g., corresponding to movement of the UE in elevation), etc.

Contents of the notification message 1018 may notify the network 1006 of a UE-preferred model ID.

Note that the notification message 1018 may be provided, for example, as part of an SR, as part of UAI, in a MAC-CE or in RRC messaging (e.g., in an RRCReconfigurationComplete message or a newly-provisioned RRC message).

Based on the notification message 1018, the network 1006 may determine which ML model to activate at the UE 1004 and may provide an activation message 1020 to the UE 1004 that instructs the UE 1004 to activate the selected ML model. The activation message 1020 may be provided, for example, as part of DCI, a MAC-CE, or RRC messaging.

The UE 1004 then proceeds to perform an inference/prediction 1022 for L1 measurements and/or RSTD-based TA mechanism measurements (as the case may be) according to the configuration(s) by the network 1006 as these are discussed. The inference/prediction 1022 may be reported to the network in a report 1024.

It is contemplated that with respect to the UE-sided procedure, either UE 1004 or the network 1006 may perform performance monitoring 1026 of the ML model (e.g., by comparing predicted measurements to corresponding actual measurements). Based on the outcome of the performance monitoring 1026, either the UE 1004 or the network 1006 may initiate LCM signaling 1028 for model switching or model deactivation, which then results in a model switch/model deactivation 1030 at the UE. In deactivation situations, it may be that the UE 1004 and the network 1006 then fallback to non-AI/ML-based measurement reporting solutions.

### Two-Sided Procedure for L1 and/or TA Measurement Predictions

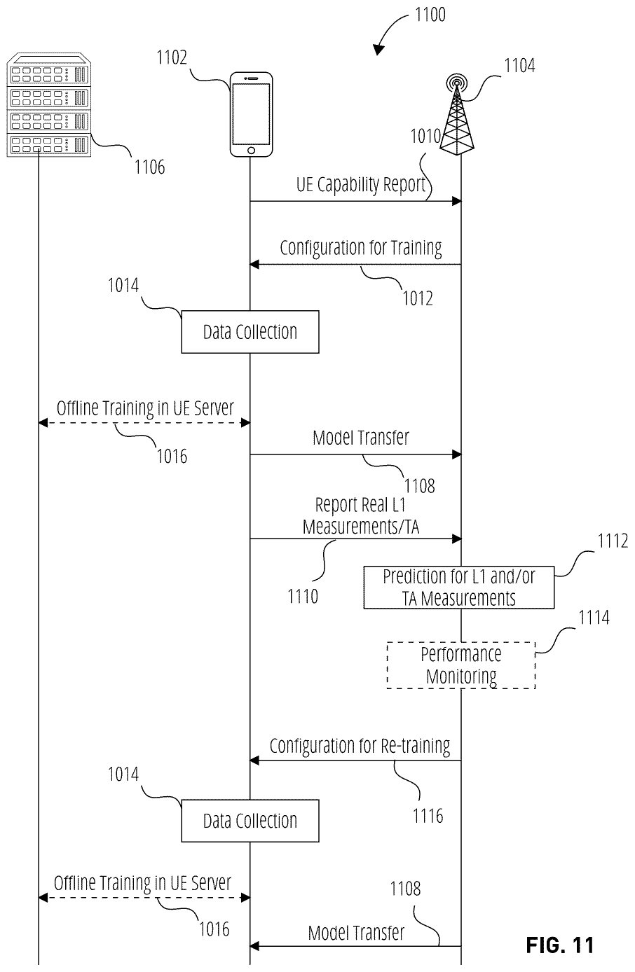

FIG. 11 illustrates a flow diagram 1100 for a two-sided procedure for L1 and/or TA measurement prediction as between a UE 1102 and a network 1104 according to embodiments herein. Note that in some embodiments, the UE-sided procedure for measurement prediction may also incorporate the use of a UE server 1106.

The UE capability reporting 1010, the training configuration 1012, the data collection 1014, and the offline training 1016 may all occur as is described herein in relation to the UE-sided procedure discussed in relation to FIG. 10.

Once the ML model is present at the UE 1102, a model transfer 1108 occurs during which the UE 1102 communicates the ML model to the network 1104. The model transfer signaling may be RRC-based or data radio bearer (DRB)-based.

Then, the UE 1102 may generate actual L1 measurements and/or actual RSTD-based TA measurements and send a measurement report 1110 having these actual measurement(s) to the network 1104.

Then network 1104 may then apply these actual L1 measurements/actual RSTD-based TA measurements with the previously-received ML model in order to perform L1 measurement/or RSTD TA measurement predictions 1112 (as the case may be). In some embodiments, the detailed prediction approach may be up to the implementation of the network 1104.

It is further contemplated that performance monitoring 1114 may occur at the network 1104 (e.g., by comparing actual L1 measurements and/or actual RSTD-based TA measurements received from the UE 1102 to the corresponding predicted L1 measurements and/or predicted RSTD-based TA measurements).

The network 1104 may further be configured to trigger the performance of ML model re-training based on its implementation (which may base this decision, for example, at least in part on results of the performance monitoring 1114). As part of triggering this re-training, the network 1104 may provide the UE with re-training configuration 1116 that instructs for the re-training (and may provide one or more parameters for the UE to analyze/use as part of the ML model re-training procedure).

In response to the re-training configuration 1116, the UE in some embodiments proceeds to again perform data collection 1014, offline training 1016, and a model transfer 1108, as previously described.

### Example Mechanisms for Making L1 Measurement Predictions

In some embodiments, a UE may be configured (e.g., via RRC signaling) for one of various alternatives of L1 measurement prediction made by an ML model (which may be referred to as a “measurement prediction model”). It is noted that L1 measurement predictions as discussed herein may correspond to beam-level measurements (and this may not be expressly mentioned in various embodiments going forward).

In a first class of embodiments for L1 measurement prediction, it may be that L1 measurement predictions correspond to temporal predictions. For example, the measurement prediction model may be for the prediction of future L1 measurements based on present inputs to the measurement prediction model.

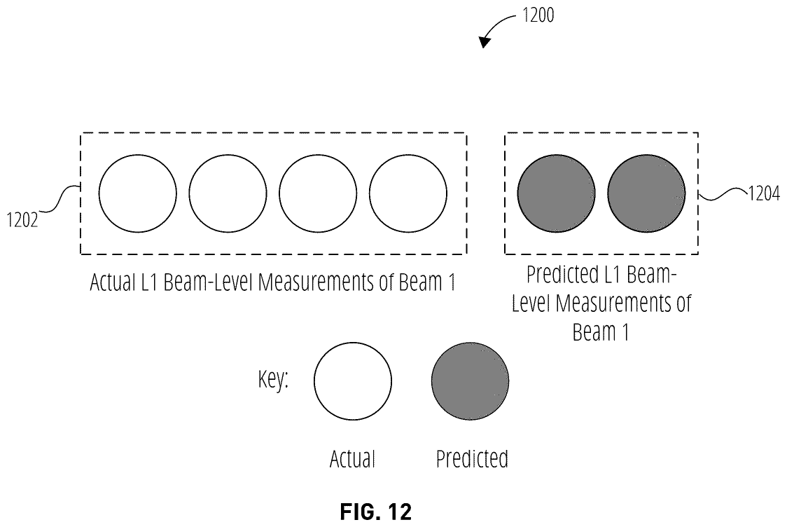

FIG. 12 illustrates a mechanism 1200 for making temporal predictions of L1 measurements, according to embodiments discussed herein. One or more actual L1 measurements 1202 (e.g., SSB and/or CSI-RS measurements) may be performed at the UE. The measurement prediction model may be configured to receive these one or more actual L1 measurements 1202 as inputs and to provide one or more predicted L1 measurements 1204 in response (where each of the one or more predicted L1 measurements 1204 corresponds to some later time). Each of the predicted L1 measurements 1204 may be for, for example, an SSB or a CSI-RS.

In a second class of embodiments for L1 measurement prediction, the L1 measurement predictions correspond to spatial predictions. For example, the UE may predict/infer one beam's (predicted) L1 measurements based on its neighbor beam(s)' actual or predicted L1 measurement(s) using its understanding of applicable spatial channel statistical information. In an example of such cases, the UE may predict one beam's L1 measurement based on a neighbor beam(s)' L1 actual measurement(s).

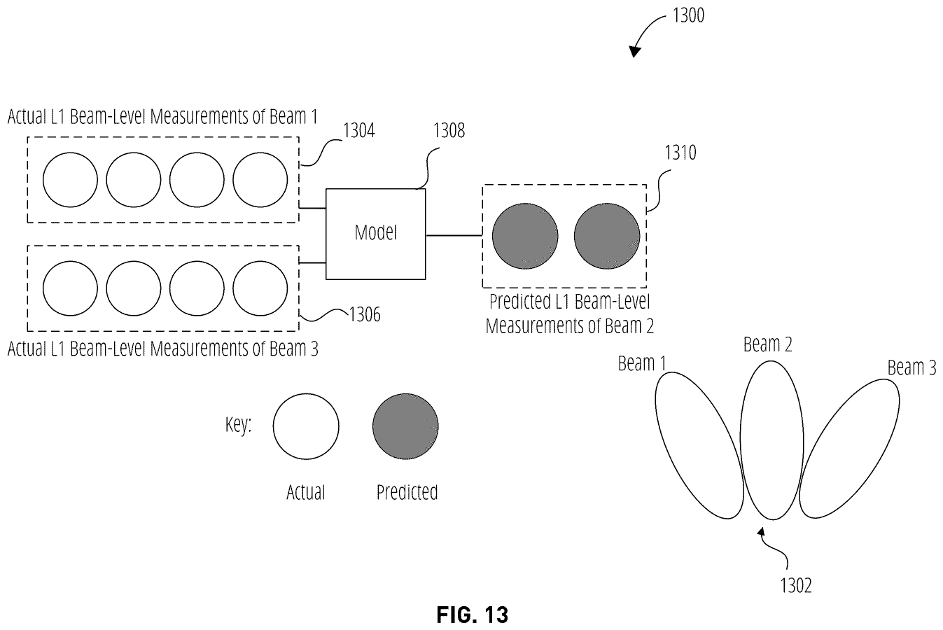

FIG. 13 illustrates a mechanism 1300 for making spatial predictions of L1 measurements, according to embodiments discussed herein. FIG. 13 illustrates a spatial beam arrangement 1302 for each of a first beam (“Beam 1”), a second beam (“Beam 2”), and a third beam (“Beam 3”).

One or more actual L1 measurements may be taken. In the example of FIG. 13, the UE takes one or more first actual L1 measurements 1304 of the first beam (Beam 1) and one or more second actual L1 measurements 1306 of the third beam (Beam 3).

The one or more actual L1 measurements (e.g., the one or more first actual L1 measurements 1304 and the one or more second actual L1 measurements 1306) are provided to a measurement prediction model 1308, which uses these items to generate one or more predicted L1 measurements 1310 for the second beam (Beam 2, which is a neighbor beam to Beam 1 and Beam 3 as illustrated). Note that in some embodiments applicable spatial channel statistical information may be used by the measurement prediction model 1308 to generate the one or more predicted L1 measurements 1310.

In some embodiments, for both temporal prediction and/or spatial prediction of L1 measurements, a dwelling/validity time for the prediction may be provided. Further, in some embodiments, for both temporal prediction and/or spatial prediction of L1 measurements, a confidence level for the prediction may be provided.

In some embodiments, it may be that both temporal prediction and spatial prediction of L1 measurement may be configured to be performed simultaneously in the two-dimensional space.

Note that configuration information (e.g., RRC configuration information) may be provided to instruct the UE regarding the use of the measurement prediction model for making L1 measurement predictions. For example, the UE may be configured to generate L1 measurement predictions with respect to particular beam(s) of particular cell(s) (e.g., present serving cell(s) and/or neighbor cell(s)).

As another example of using L1 measurement predictions according to configuration information, the UE may be configured to generate L1 measurement predictions based on one or more conditions.

In a first example of the use of conditions for using predicted L1 measurements, the UE may be configured to generate L1 measurements for up to a number N of beams, where the UE generates actual L1 measurements for a number of M beams (M<N) known to previously have a strongest RSRP/RSRQ, and further generates predicted L1 measurements for the remaining N-M beams. In the case that a predicted L1 measurement falls into the M highest measurements, then the UE will perform actual L1 measurement of that beam going forward (and the last beam of the prior set of M joins the N-M set for which predictions are instead used).

In a second example of the use of conditions for using predicted L1 measurements, a configured RSRP/RSRQ/SINR threshold may be compared with an actual or predicted L1 measurement. If a cell's actual or predicted L1 measurement is less than the threshold, the UE performs L1 measurement prediction for the beam. In a variation of this case, it may be that the base station configures the UE to use separate thresholds with respect to the use of actual L1 measurements and predicted L1 measurements.

In a third example of the use of conditions for using predicted L1 measurements, a configured interference measurement threshold may be used. In this case, the UE may use L1 measurement prediction in cases where the strength of interference in the beam is above a threshold.

In a fourth example of the use of conditions for using predicted L1 measurements, two thresholds may be used. A first configured RSRP threshold may be compared with an actual/predicted L3 cell-level measurement for a cell. If the cell's actual or predicted L3 cell-level measurement is greater than a threshold, the UE may perform L1 (beam-level) measurement prediction for one or more beams in that cell. Then, a second configured RSRP/RSRQ threshold may be compared with an actual or predicted L1 measurement for a beam of that cell to determine whether to use actual or predicted L1 measurement for the beam in the cell going forward.

In a fifth example of the use of conditions for using predicted L1 measurements, L1 measurement predictions may be performed for all inter-frequency measurements.

In a sixth example of the use of conditions for using predicted L1 measurements, L1 measurement predictions may be performed if the measurement uses a measurement gap (for example, for measurements for another frequency or another non-overlapping BWP).

As another example of using L1 measurement predictions according to configuration information, the configuration information may indicate neighbor cell(s) and/or frequency(s) for which the UE is allowed to autonomously/independently choose to generate either actual L1 measurements or predicted L1 measurements.

### Embodiments for Reporting Actual and/or Predicted L1 Measurements

It is contemplated that both periodic and event-triggered L1 measurement reporting may be supported.

In some embodiments, for periodic L1 measurement reporting, the UE may be configured by the network with two periodicities in one reporting configuration. A first of the two periodicities may be a predicted measurement periodicity that indicates how often the UE should perform and/or report AI/ML-based L1 measurement predictions. A second of the two periodicities may be an actual measurement periodicity that indicates how often the UE should perform and/or report actual L1 measurements. In some such embodiments the predicted measurement periodicity may be less than the actual measurement periodicity, such that the UE can use L1 measurement prediction most of time (e.g., to reduce power), while still occasionally reporting actual L1 measurements to provide more accurate updating/information usable for model monitoring.

In some embodiments, for event-triggered reporting, the UE may be configured to use actual and/or predicted L1 measurements to trigger measurement reporting event(s). Examples of such event may include a first event where an actual or predicted L1 measurement is less than a threshold, a second event where a first actual or predicted L1 measurement at a serving cell is less than a first threshold and a second actual or predicted L1 measurement at a neighbor cell is greater than a second threshold, and/or a third event where a first actual or predicted L1 measurement at a neighbor cell is better than a second actual or predicted L1 measurement at a serving cell by more than/greater than a threshold.

It may be that a UE may be configured with whether predicted L1 measurements may trigger a measurement reporting event (e.g., as opposed to the case where only actual L1 measurements are used to trigger a measurement reporting event). In such cases where predicted L1 measurements may be used, the UE may further be configured to trigger a measurement reporting based on a predicted measurement L1 measurement (e.g., only) when a confidence level for the predicted L1 measurement(s) are greater than a threshold value.

Note that in cases where L1 measurements of neighbor cells are analyzed, the UE may be configured as to whether predicted L1 measurement is used only for neighbor cell (and not, e.g., the serving cell).

It is contemplated that with respect to these cases, the UE may further be configured to also use, for example, one or more of events A1-A6 as may be understood in an NR wireless communication system with respect to any predicted L3 cell-level measurement(s) (e.g., if a confidence level for the predicted L3 cell-level measurement(s) are greater than a corresponding threshold).

Whatever the case, once a measurement reporting event is triggered, the UE may report available predicted and/or actual L1 measurements as part of the measurement reporting.

In some embodiments, for both periodic and event-triggered reporting, the UE may first report actual L1 measurements and then predicted L1 measurements. In a first case, the order to report such L1 measurements may then be based on measurement quantities (RSRP/RSRQ) (e.g., from high to low).

In a second case, the order to report such L1 measurements may be based on a confidence level for any predictive measurements (e.g., from high to low).

In a third case, the order to report such L1 measurements may be to first report SSB measurements then report CSI-RS measurements.

Note that any combination of above three cases is possible. For example, a UE may be configured to report SSBs first, and then highest RSRPs first, and finally CSI-RSs (in the case for example, where more than one SSB has the same RSRP).

Within the measurement report, the UE indicates which L1 measurements are predictive measurements and/or which L1 measurements are actual measurements. The UE may further, in at least some embodiments, indicate a reliability probability or confidence level of any predictive measurement(s) in cases where predictive measurement(s) are included in the measurement report.

It may be that with respect to the use of L1 measurement predictions, the total number of parallel predictions in the measurement reporting is within a capability of the UE. In some cases, the base station configures the UE to make a number of predictions that is within this UE capability (e.g., may selected to take measurements corresponding to previously-reported high channel conditions).

In cases where one or more measurement predictions are dropped by the UE to remain within its capability, the UE may drop predictions corresponding to poor channel conditions; drop predictions for beams corresponding to a poor confidence level; and/or drop predictions that are based on a CSI-RS. Note further that any combination of these criteria could be used for dropping purposes.

### Example Mechanisms for Making RSTD-Based TA Measurement Predictions

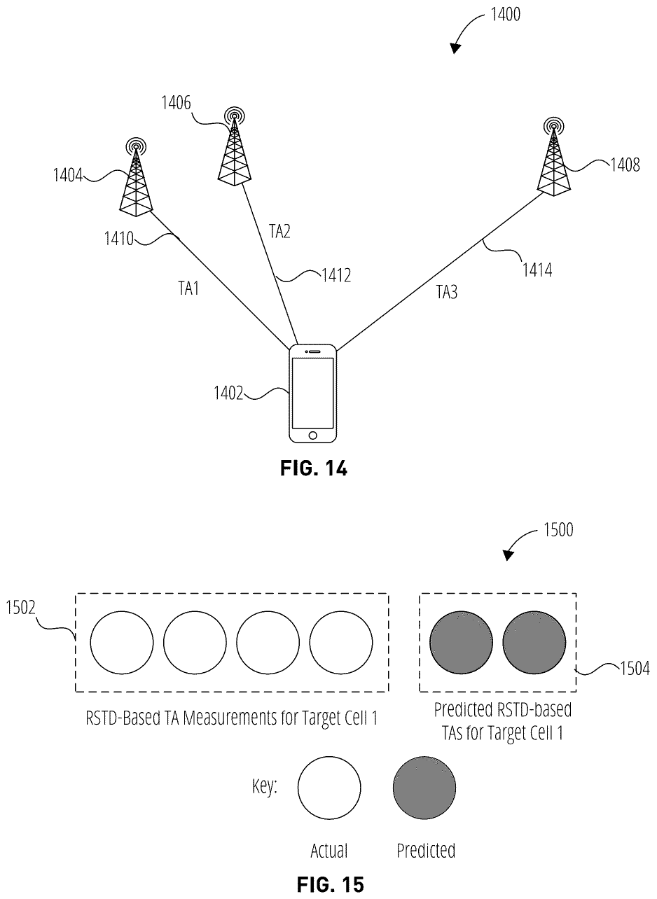

FIG. 14 illustrates a diagram 1400 for an example case for various TAs between a UE 1402 and each of a first cell 1404, a second cell 1406, and third cell 1408. As illustrated in FIG. 14, each of the first cell 1404, the second cell 1406, and the third cell 1408 may be sited at different locations relative to the UE 1402. Accordingly, a first TA 1410 for communications between the UE 1402 and the first cell 1404, a second TA 1412 for communications between the UE 1402 and the second cell 1406, and a third TA 1414 for communications between the UE 1402 and the third cell 1408 may all be independent and/or different from one another.

In some embodiments, a UE may be configured (e.g., via RRC signaling) for one of various alternatives of RSTD-based TA measurement prediction made by an ML model (which may be referred to as a “measurement prediction model”).

In a first class of embodiments for RSTD-based TA measurement prediction, it may be that the RSTD-based TA measurement prediction corresponds to temporal predictions. For example, the measurement prediction model may be for the prediction of future RSTD-based TA measurements based on present inputs to the measurement prediction model.

FIG. 15 illustrates a mechanism 1500 for making temporal predictions of RSTD-based TA measurements, according to embodiments discussed herein. One or more actual RSTD-based TA measurements 1502 may be performed at the UE. The measurement prediction model may be configured to receive these one or more actual RSTD-based TA measurements 1502 as inputs and to provide one or more predicted RSTD-based TA measurements 1504 in response (where each of the one or more predicted RSTD-based TA measurements 1504 corresponds to some later time).

In a second class of embodiments for RSTD-based TA measurement prediction, the RSTD-based TA measurement prediction corresponds to spatial predictions. For example, the UE may predict/infer one cell's (predicted) RSTD-based TA measurement based on its neighbor cell(s)' actual or predicted RSTD-based TA measurement(s) using its understanding of applicable spatial channel statistical information. For example, the UE may predict one cell's RSTD-based TA measurement based on a neighbor cell(s)' RSTD-based TA actual measurement(s).

For spatial prediction, the UE may predict one candidate cell's TA based on another candidate cell's actual RSTD-based TA measurement. In such cases, the network may provide the UE with various information (e.g., base station deployment geometry) as assistance information.

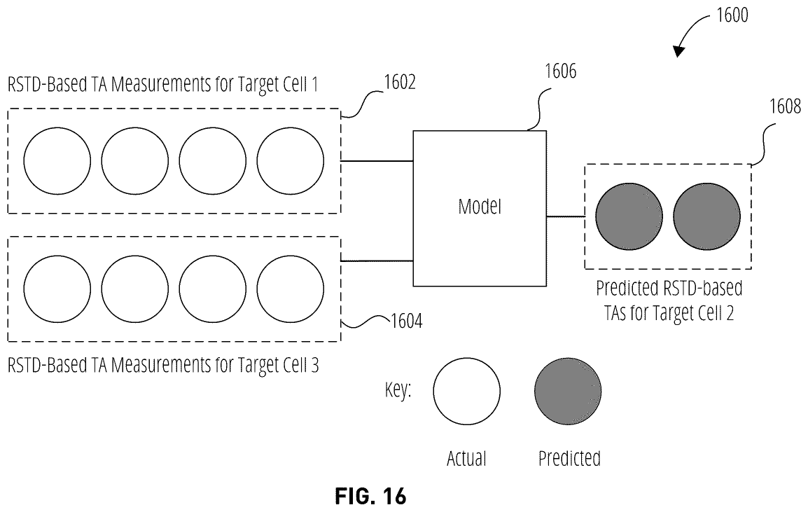

FIG. 16 illustrates a mechanism 1600 for making spatial predictions of RSTD-based TA measurements, according to embodiments discussed herein. FIG. 16 corresponds to a spatial cell arrangement for each of a first cell (e.g., the first cell 1404 of FIG. 14), a second cell (e.g., the second cell 1406 of FIG. 14), and a third cell (e.g., the third cell 1408 of FIG. 14).

One or more actual RSTD-based TA measurements may be taken. In the example of FIG. 16, the UE takes one or more first actual RSTD-based TA measurements 1602 of the first cell and one or more second actual RSTD-based TA measurements 1604 of the third cell.

The one or more actual RSTD-based TA beam level measurements (e.g., the one or more first actual RSTD-based TA measurements 1602 (e.g., of the first cell 1404) and the one or more second actual RSTD-based TA measurements 1604 (e.g., of the third cell 1408)) are provided to a measurement prediction model 1606, which uses these items to generate one or more predicted RSTD-based TA beam-level measurements 1608 for the second cell (e.g., the second cell 1406). Note that in some embodiments applicable spatial channel statistical information may be used by the measurement prediction model 1606 to generate the one or more predicted RSTD-based TA beam-level measurements 1608.

In some embodiments, for both temporal prediction and/or spatial prediction of RSTD-based TA measurements, a dwelling/validity time for the prediction may be provided. Further, in some embodiments, for both temporal prediction and/or spatial prediction of RSTD-based TA measurements, a confidence level for the prediction may be provided.

In some embodiments, it may be that both temporal prediction and spatial prediction of RSTD-based TA measurements may be configured to be performed simultaneously in the two-dimensional space.

### Embodiments for Reporting Actual and/or Predicted RSTD-Based TA Measurements

It is contemplated that both periodic and event-triggered RSTD-based TA measurement reporting may be supported.

In some embodiments for periodic RSTD-based TA measurement reporting, the UE may be configured by the network with two periodicities in one reporting configuration. A first of the two periodicities may be a predicted measurement periodicity that indicates how often the UE should perform and/or report AI/ML-based RSTD-based TA measurement predictions. A second of the two periodicities may be an actual measurement periodicity that indicates how often the UE should perform and/or report actual RSTD-based TA measurements.

For embodiments of event triggered reporting, the UE may be configured with a new TA-related event (e.g., “Event-4”). This event may occur when a change to a candidate cell's RSTD-based TA compared with a last reporting instance for that value is greater than a threshold. It is contemplated that the network may configure to the UE whether an actual RSTD-based TA measurement and/or a predicted RSTD-based TA measurement may trigger the event. In addition or alternatively, it may be configured that with respect to the use of a predicted RSTD-based measurement, the event is triggered only when a confidence level for the predicted RSTD-based measurement is greater than a threshold.

Whatever the case, once a measurement reporting event is triggered, the UE may report available predicted and/or actual RSTD-based TA measurements as part of the measurement reporting.

In some embodiments, for both periodic and event-triggered reporting, the UE may first report actual RSTD-based TA measurements and then predicted RSTD-based TA measurements. In a first case, the order to report such RSTD-based TA measurements may then be based on cell-level L3 measurement quantities (RSRP/RSRQ/SINR) from high to low.

In a second case, the order to report such RSTD-based TA measurements may be based on a confidence level for any predictive measurements (e.g., from high to low).

Note that any combination of above two cases is possible. For example, a UE may be configured to report based on cell-level L3 measurement quantities first, and then on confidence levels for any predictive RSTD-based TA measurements second.

Within the measurement report, the UE may indicate which RSTD-based TA measurements are predictive measurements and/or which RSTD-based TA measurements are actual measurements. The UE may further, in at least some embodiments, indicate a reliability probability or confidence level of any predictive measurement(s) in cases where predictive measurement(s) are included in the measurement report.

It may be that with respect to the use of RSTD-based TA measurement predictions, the total number of parallel predictions in the measurement reporting is within a capability of the UE. In some cases, discarding of any extra RSTD-based TA measurements/predictions may be done according to, for example, a measurement reporting order for RSTD-based TA measurement predictions (e.g., as discussed herein).

### Model Monitoring and LCM for L1 Measurement Predictions and/or RSTD-Based TA Measurement Predictions

It is contemplated that, with respect to UE-sided procedures for L1 measurement prediction and/or RSTD-based TA measurement prediction, model monitoring (e.g., monitoring of the performance of the ML model) may be performed at the UE and/or at the base station. In the case that model monitoring is performed at the base station, the procedure may be up to a base station implementation.

In the case that model monitoring is performed at the UE, a model monitoring metric used by the UE may be, in some such embodiments, an error between predicted L1 measurement(s)/RSTD-based TA measurement(s) and corresponding actual L1 measurement(s)/RSTD-based TA measurement(s). For example, an MSE between some predicted L1 measurement(s)/RSTD-based TA measurement(s) and corresponding actual L1 measurement(s)/RSTD-based TA measurement(s) may be used (and note that the use of a MSE metric in this manner may be an example of a “confidence level” as discussed herein). For monitoring purposes, a UE may perform both predicted L1 measurement(s)/RSTD-based TA measurement(s) and corresponding actual L1 measurement(s)/RSTD-based TA measurement(s) for one small set of cell(s) and/or beam(s) (as the case may be).

It is contemplated that the ML model being used may be switched from time to time, (e.g., a different ML model will be selected for use and/or the use of an ML model to make predictions may be paused or stopped). This may occur, for example, based on a result of model monitoring, as will be described. A UE may be configured to perform either a UE-initiated model switch or a network-initiated model switch.

In the case of a UE-initiated switch, the UE may be configured with a condition and UE behaviors regarding a model metric (e.g., a confidence level). For example, the UE may be configured with a MSE with a 0.01 threshold. When the MSE is greater than 0.01, the UE may be configured to fallback to a conventional measurement.

In the case of a network-initiated switch, the UE may report the model monitoring metric (e.g., confidence level), and may wait for the base station LCM signaling in response (e.g., an instruction to stop using the ML model and/or to begin the use of a different ML model). The UE may report the model monitoring metric via UAI or a MAC-CE.

Note that the network may provide the UE with assistance information that is useable by the UE with respect to model monitoring that occurs at the UE side. This assistance information may include for example, any one or more of: a nearby base station deployment geometry; statistics of temporal correlation; and/or long-term statistics of inter-cell correlation or inter-beam correlation.

For two-sided procedures for L1 measurement prediction and/or RSTD-based TA measurement prediction, model monitoring may be performed at the base station side, and it may be up to the gNB implementation.

With respect to UE-sided and/or two-sided procedures for L1 measurement prediction and/or RSTD-based TA measurement prediction that use base station monitoring of the ML model, it may be that the UE may be configured to provide the base station with information to help the base station to perform the monitoring. Such information may include, extra temporal information such as a timestamp(s) for prediction(s) and/or timestamp(s) of corresponding actual measurement(s). Such information may also/alternatively include extra spatial information such as the UE's actual position, the UE's actual moving orientation, a change to the UE's moving orientation, and/or the a delta (difference in) direction that may be compared with the prediction.

### Base-Station-Sided Procedure for Early TA Predictions

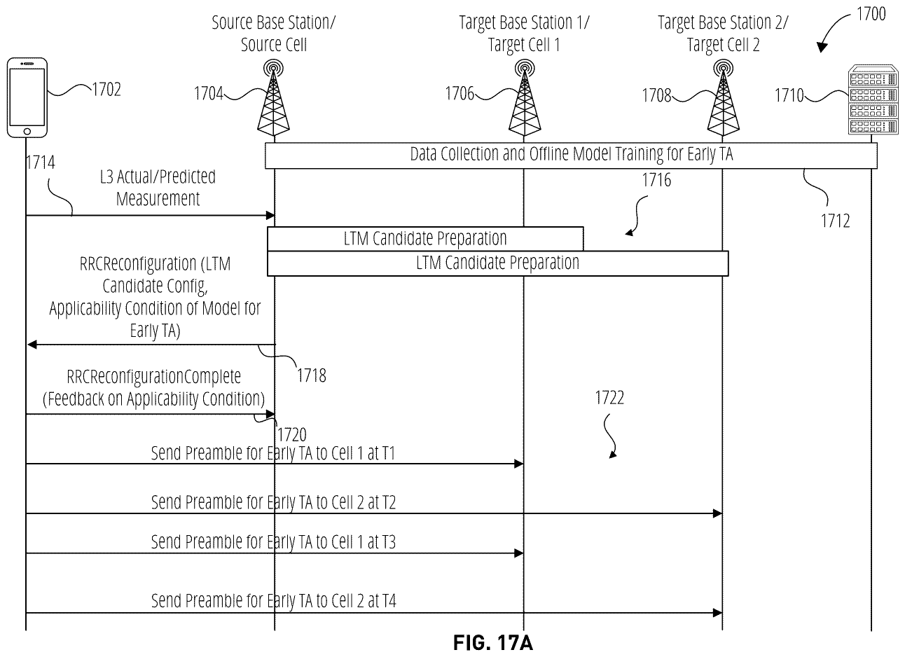

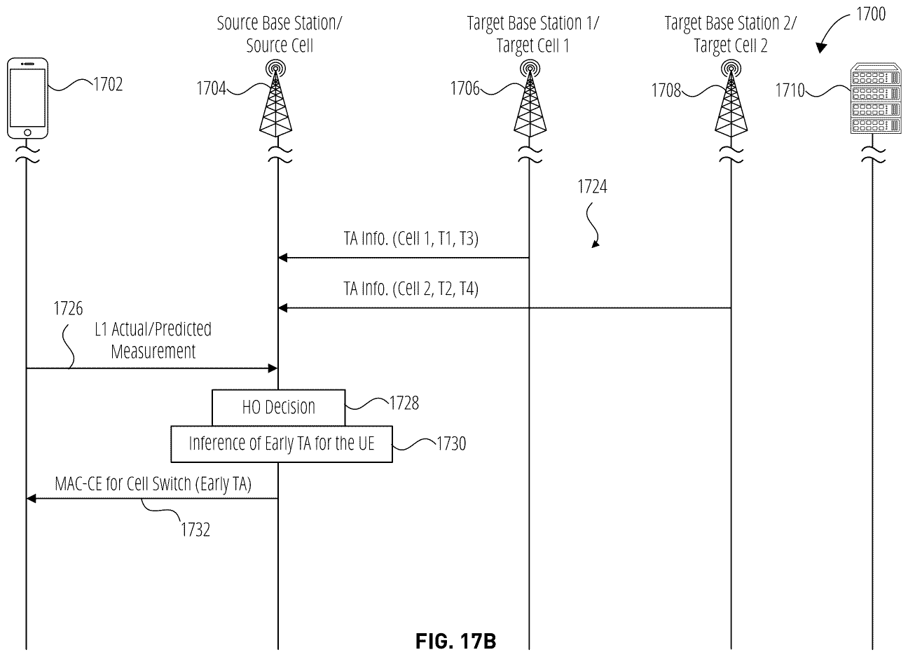

FIG. 17A ad FIG. 17B together illustrate a flow diagram 1700 for implementing predictions of early TA in a system including a UE 1702, a source base station 1704 communicating with a UE on a serving cell, a first target base station (“Target Base Station 1”) having a first target cell 1706, a second target base station (“Target Base Station 2”) having a second target cell 1708, and a server 1710, according to embodiments discussed herein. Note that with respect to the use of early TA mechanisms, a base-station-sided procedure may be suitable because the TA is maintained on the base station side.

The flow diagram 1700 begins with the data collection and offline model training 1712. Then, the UE 1702 sends the source base station 1704 actual and/or predicted L3 cell-level and/or beam/level measurements 1714. These measurements may indicate to the source base station 1704 that the first target cell 1706 and the second target cell 1708 are appropriate target cells.

The source base station 1704 proceeds to perform LTM candidate preparation 1716 with the first target cell 1706 and the second target cell 1708, as illustrated, such that the first target cell 1706 and the second target cell 1708 are ready to act according to LTM.

The source base station 1704 then sends the UE 1702 a configuration message 1718 (e.g., an RRCReconfiguration message) indicating the candidate configurations for the first target cell 1706 and the second target cell 1708. Further, the source base station 1704 may include an applicability condition request corresponding to an applicability condition for selecting a ML model that is to be used by the base station. For example, an upcoming use of a UE speed threshold may be indicated in the configuration message 1718 for selecting a suitable ML model.

The UE may provide a configuration response 1720 to the source base station 1704 in response to its receipt of the configuration message 1718. The configuration response 1720 may include feedback for the applicability condition indicated in the configuration message 1718 in the form of an applicability condition response that informs the source base station 1704 of a value for the applicability condition. Based on the value of the applicability condition received in the configuration response 1720, the source base station 1704 may identify a ML model for early TA prediction (e.g., from a plurality of such models that may exist at the source base station 1704). Note that it is contemplated that the UE may provide updated feedback (e.g., an updated value of the applicability condition) to the source base station 1704 via UAI at any time.

The UE 1702 then sends preambles 1722 to each of the first target cell 1706 and the second target cell 1708. The UE 1702 sends a first preamble to the first target cell 1706 at a first time (“T1”), a second preamble to the second target cell 1708 at a second time (“T2”), a third preamble to the first target cell 1706 at a third time (“T3”), and a fourth preamble to the second target cell 1708 at a fourth time (“T4”), as illustrated.

After receiving the preambles 1722, the first target base station for the first target cell 1706 and the second target base station for the second target cell 1708 each send TA information 1724 to the source base station 1704. The TA information 1724 may comprise collected data corresponding to the preambles 1722 and may be sent to the source base station 1704 an inter-node signaling procedure.

The TA information 1724 may include a UE ID for the UE 1702.

The TA information 1724 for the sending target cell may further include a TA value corresponding for the UE 1702 to use for transmissions to the sending target cell. This TA value may have been determined at the network using times corresponding to the one or more preambles that were sent to that target cell by the UE 1702, as is discussed herein.

The TA information 1724 for the sending target cell may further include one or more timestamps corresponding to the preamble(s) used to generate the reported TA value for the sending target cell (e.g., as illustrated in the TA information 1724 of FIG. 17B).

Note that TA information 1724 may generally be considered include additional instances of analogous communication between the first target cell 1706 and the second target cell 1708 beyond those the ones expressly illustrated (e.g., may include unillustrated information with respect to unillustrated prior preambles earlier than the preambles 1722).

The source base station 1704 may then receive one or more actual or predicted L1 measurements 1726 from the UE 1702. Based on these actual or predicted L1 measurements 1726, the source base station 1704 may make a HO decision 1728 in which it selects one of the first target cell 1706 and the second target cell 1708 with which the UE should perform a handover.

After making the HO decision 1728, the source base station 1704 may apply the TA information 1724 to the selected ML model to generate a predicted early TA 1730. In some examples, the predicted early TA 1730 is a joint temporal-spatial prediction.

The predicted early TA 1730 may then be included in a cell switch command 1732 (e.g., a MAC-CE cell switch command) that is sent to the UE 1702 to cause the UE to perform LTM to the selected target cell (the selected one of the first target cell 1706 and the second target cell 1708). As part of this LTM, the UE uses the predicted early TA 1730 received from the source base station 1704 to adjust its transmission timing with respect to the selected target cell.

Note that in such embodiments, model monitoring may be on the network side, and may be up to the network implementation.

### Embodiments of Failure Handling With Respect to Using Predicted L1 Measurements

In some embodiments, if an LTM execution has failed (for example, as caused/determined by the expiration of an LTM supervisor timer) the UE may perform cell selection procedures in a manner that considers the (potential) use of predicted L1 measurements. For example, if configured candidate target cell(s) become suitable, the UE may choose a target cell via the following prioritization rules. First, the UE may choose among cells with actual L1 measurements (e.g., L1 RSRP/RSRQ) from high to low. Then, the UE may choose to follow the confidence level for cells with only predicted L1 measurements.

Note that these prioritization rules are given by way of example and not by way of limitation. It is anticipated that prioritization rules for this situation could vary based on UE implementation.

### Conditional Handover Methods

CHO is a feature that is used to improve mobility robustness. In CHO, a UE may be configured with a handover command and an associated CHO condition(s) (sometimes alternatively referred to as “event condition(s),” “trigger condition(s)” or “condition(s)”) to be monitored. The UE may execute the stored “handover” command when the associated condition(s) become true. Event conditions may include, for example, when a neighbor cell becomes better than a special cell (SpCell) by an offset (e.g., an A3 event condition) or when the SpCell becomes worse than a first threshold and the neighbor cell becomes better than a second threshold (e.g., an A5 event condition. The SpCell is the primary serving cell of either the Master Cell Group (MCG) or a Secondary Cell Group (SCG), and the offset may be either positive or negative.

When more than one candidate target cell satisfies a condition, it may be up to the UE implementation to determine the cell with which the UE executes the HO. In certain wireless communication systems (e.g., 3GPP Release 17 wireless communication systems), new conditional trigger conditions related to location and time may be defined to help enhance CHO for non-terrestrial networks (NTNs).

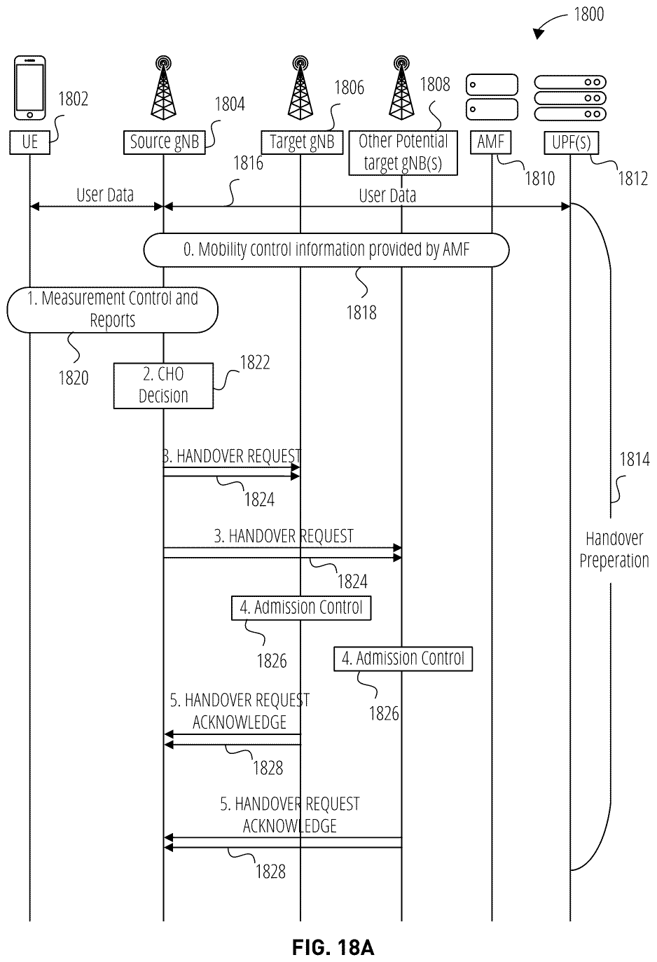

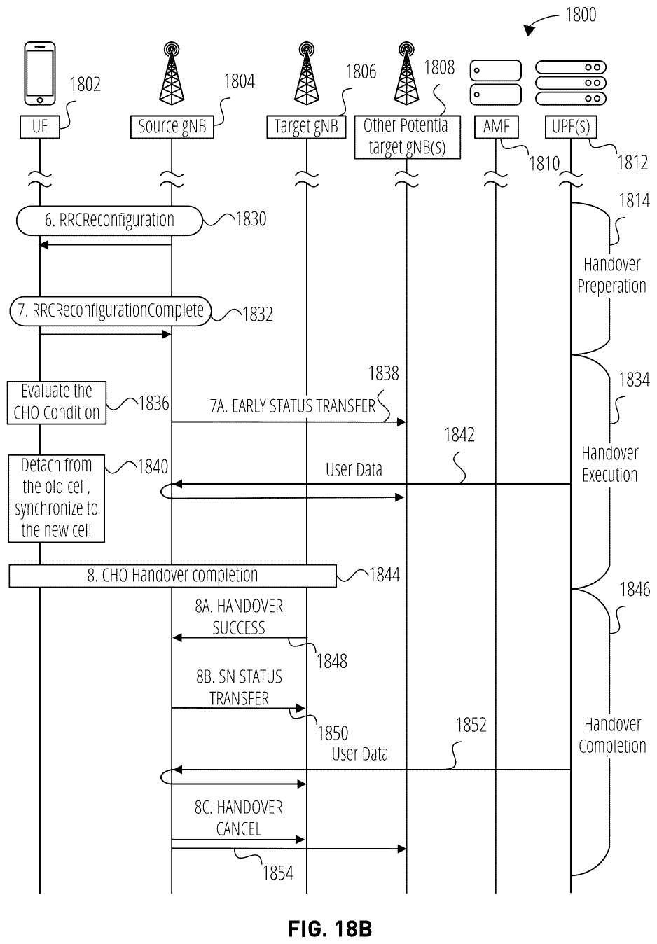

FIG. 18A and FIG. 18B together illustrate a flow diagram 1800 for conditional handover that may be used in some wireless communications systems. The flow diagram 1800 illustrates a wireless communication system that includes a UE 1802, a source gNB 1804, a target gNB 1806, other potential target gNB(s) 1808, an access and mobility management function (AMF) 1810, and one or more user plane functions (UFP(s)) 1812. As can be seen, the flow diagram 1800 corresponds to an intra-AMF/UPF case. Note that the source gNB 1804, the target gNB 1806, and the other potential target gNB(s) 1808 could each (e.g., independently) be base station types other than gNBs in other embodiments.

As illustrated in FIG. 18A, the flow diagram 1800 begins with the handover preparation phase 1814. Presently, user data 1816 is transported between the UE 1802 and the source gNB 1804 and between the source gNB 1804 and the UFP(s) 1812, as illustrated. The AMF 1810 provides the source gNB 1804 with mobility control information 1818. Then, the source gNB 1804 configures measurements at the UE 1802, and the UE 1802 performs measurements and reports measurement results to the source gNB 1804, during the measurement control and reports 1820. Based on the receipt of the measurement reporting, the source gNB 1804 makes a CHO decision 1822. Based on the CHO decision 1822, the source gNB 1804 sends handover requests 1824 to other gNBs (in the flow diagram 1800, both the target gNB 1806 that will ultimately be selected as the target of the handover and other potential target gNB(s) 1808 are illustrated as receiving the handover requests 1824).

The other gNBs (e.g., the target gNB 1806 and the other potential target gNB(s) 1808) each perform admission control 1826, and reply to the source gNB 1804 with a handover request acknowledgement 1828, including configuration of any CHO candidate cell(s) at that gNB.

FIG. 18B continues the flow diagram 1800 discussed above in relation to FIG. 18A. The source gNB 1804 sends the UE 1802 an RRCReconfiguration message 1830 having the configuration for the CHO candidate cells (CHO configurations for the candidate cells). The UE 1802 sends the source gNB 1804 an RRCReconfigurationComplete message 1832.

The flow diagram 1800 then enters the handover execution phase 1834. The UE 1802 evaluates 1836 the CHO condition. Further, in some embodiments (e.g., where early data forwarding is used) the target gNB 1806 sends the other potential target gNB(s) 1808 an early status transfer message 1838.

Then, the UE 1802 detaches 1840 from the old cell and synchronizes to a new cell (e.g., on the target gNB 1806). As part of this process, the UE performs an evaluation of conditions on the candidate cell(s) and determines that the new cell (on the target gNB 1806) meets the conditions and that it will accordingly handover to that cell. The configuration for that new cell is then applied at the UE.

Further, user data 1842 is transported between the UFP(s) 1812 and the target gNB 1806 and/or the other potential target gNB(s) 1808 via the source gNB 1804. The CHO handover completion 1844 occurs once the UE 1802 becomes associated with the new cell on the source gNB 1804 (and the UE 1802 may send an attendant RRCReconfigurationComplete message to the target gNB 1806).

The flow diagram 1800 then enters the handover completion phase 1846. First, the target gNB 1806 sends the source gNB 1804 a handover success message 1848.

Then, the source gNB 1804 sends the target gNB 1806 a sequence number (SN) status transfer 1850. User data 1852 is transported between the UFP(s) 1812 and the target gNB 1806 via the source gNB 1804. Finally, the source gNB 1804 may send the target gNB 1806 and/or the other potential target gNB(s) 1808 a handover cancel message 1854.

### Overview of Measurement Predictions Used in CHO Methods

Details with respect to the generation and use of AI/ML-based CHO enhancement at the UE are now discussed. In some cases, the use of AI/ML-based CHO enhancements may result in a reduction in the reserved radio resource of candidate target cell(s) that is based on predicted L3 measurement. In such cases, the UE can suggest to change bad CHO conditions, for example, candidate target cell(s) which are not likely to meet the CHO condition within in a relevant time, a CHO event type, and/or an applicable threshold.

In some cases, the use of AI/ML-based CHO enhancements may result in a reduction in the time to start a CHO execution. For example, a CHO may be executed when predicted L3 measurements satisfy the CHO condition, (e.g., rather than waiting for actual L3 measurements to satisfy the CHO condition).

In some cases, the use of AI/ML-based CHO enhancements may have the effect of making a UE's target cell selection more robust. According to some existing/defined CHO procedures, it may be up to a UE implementation to select target cell in the case that more than one target cell satisfies the applicable CHO condition(s). Accordingly, in some cases, measurement predictions may be used to further choose as between such cells.

Herein, aspects of an overall procedure between a base station and UE with respect to AI/ML enhanced CHO mechanisms are discussed. Further, new CHO configurations that may be used in such contexts are discussed. Still further, UE behavior with respect to CHO condition evaluation in such contexts is discussed. Still further, assistance information that may be provided from UE to a source cell/source base station (e.g., via an RRCReconfigurationComplete message or UAI) in such contexts is discussed. Finally, aspects regarding UE behavior for failure handling in such contexts are discussed.

### Procedures for CHO Using Measurement Predictions

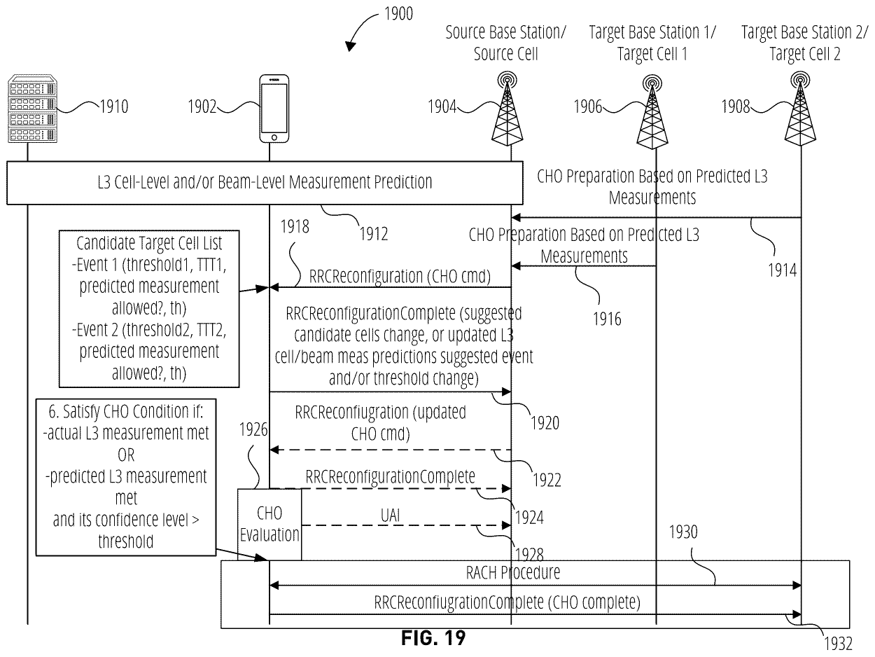

FIG. 19 illustrates a flow diagram 1900 for a CHO procedure using measurement predictions that uses a UE 1902, a source base station 1904 communicating with a UE on a serving cell, a first target base station (“Target Base Station 1”) having a first target cell 1906, a second target base station (“Target Base Station 2”) having a second target cell 1908, and a server 1910, according to embodiments discussed herein.

As illustrated, the UE 1902, the source base station 1904, and the server 1910 work together to generate one or more L3 cell-level and/or beam-level measurement predictions 1912 corresponding to one or more of the first target cell 1906 and/or the second target cell 1908. These are ultimately reported by the UE 1902 to the source base station 1904. This may occur as has been discussed elsewhere herein.

The source base station 1904 may then perform a first CHO preparation 1914 with the first target base station with respect to the first target cell 1906, as illustrated.

The first CHO preparation 1914 may be based on UE reported prediction of L3 cell/beam level measurements of/corresponding to the first target cell 1906 (and this may include, in some cases, analysis of any corresponding confidence level for these predicted L3 measurements as may have also been provided by the UE 1702).

The source base station 1904 may also perform an analogous second CHO preparation 1916 with the second target base station with respect to the second target cell 1908 (and for analogous reasons), as illustrated.

In some cases, particular metrics and procedures for selecting cells for CHO preparation as described may be according to a particular implementation at source cell implementation.

The UE source base station 1904 then provides the UE 1902 with a CHO configuration 1918 (e.g., in an RRCReconfiguration message, as illustrated). As illustrated, the CHO configuration 1918 may be understood as CHO command in some contexts. The CHO configuration 1918 may provide a candidate target cell list that identifies each of the first target cell 1906 and the second target cell 1908 as candidate target cells.

Further, the CHO configuration 1918 may include and one or more CHO events corresponding to one or more CHO condition(s) (e.g., relevant threshold(s) for measurement(s)) that are to be evaluated with respect to candidate target cells to determine whether HO should be executed toward a particular candidate target cell. By way of example, with respect to some 3GPP wireless communication systems, these CHO events may include events A3, A4, and/or A5.

For each configured measurement-based CHO event, the CHO configuration 1918 may provide an indication on whether predicted L3 measurements can be used for evaluation the corresponding CHO condition(s).

Further, for each configured measurement-based CHO event, the CHO configuration 1918 may provide a confidence threshold (illustrated as “th” in FIG. 19) for using predicted L3 measurements for CHO condition evaluation in the case that the use of predicted L3 measurements is allowed.

It is contemplated that the CHO configuration 1918 could include multiple sets of CHO conditions and criterion for choosing a particular one of these CHO conditions for use. For example, UE mobility speed threshold(s) may be indicated with respect to the use of various such CHO conditions.

In some cases, the CHO configuration 1918 may also include a priority value for each candidate target cell.

In response to its receipt of the CHO configuration 1918, the UE 1902 provides the source base station 1904 with a CHO configuration response 1920 (e.g., an RRCReconfigurationComplete message). The UE may include various information in the CHO configuration response 1920.

In some cases, the CHO configuration response 1920 may include a suggested change to a target cell list used by the source base station 1904. This may help to reduce any mismatch between the predicted L3 measurement reporting by the UE 1902 and a currently applicable channel observation (e.g., corresponding to the CHO configuration 1918), which may be out of date.

In some cases, the CHO configuration response 1920 may include an updated L3 cell-level/beam-level measurement predictions. This may help to reduce any mismatch between the predicted L3 measurement reporting by the UE 1902 and a currently applicable channel observation (e.g., corresponding to the CHO configuration 1918), which may be out of date.

In some cases, the CHO configuration response 1920 may include a prediction error metric for one of the predicted L3 measurements (e.g., an MSE as between the predicted L3 measurement and its actual L3 measurement) In some cases, the CHO configuration response 1920 may include a suggested change to the CHO configuration information, including, but not limited to, a change of a CHO event type; a change of CHO condition(s)/threshold(s) used to evaluate whether the CHO event has occurred; a change to a TTT value; and/or a suggested priory value change for a cell.

Note that while the CHO configuration response 1920 has been illustrated as using an RRCReconfigurationComplete message, it is also contemplated that the information found therein could instead/additionally be carried in a MAC-CE and/or in a new/some other UL RRC message.

It is noted that in at least some cases, the contents of the CHO configuration response 1920 may depend on the contents of the CHO configuration 1918.

As illustrated, the source base station 1904 may the optionally provide an update 1922 to the CHO configuration to the UE 1902 (e.g, based on information it received in the CHO configuration response 1920). The mechanism for such updates may be according to a particular implementation of the source base station 1704. As illustrated, the update 1922 may be sent in an RRCReconfiguration message, and that the UE may further provide the source base station 1904 with a response 1924 (e.g., an RRCReconfigurationComplete message) to the update 1922.

The UE 1902 then proceeds into a CHO evaluation period 1926, where CHO condition(s) of the CHO configuration(s) are actively monitored with respect to actual L3 cell-level and/or beam-level measurements and/or predicted L3 cell-level and/or beam-level measurements that are generated from time to time at the UE 1902.

Note that the CHO evaluation period 1926, the UE may send a UAI message 1928 to the source base station 1904 to any one or more of: a suggested change on candidate target cell list; a suggested target cell to execute non-conditional (e.g., regular) HO; and/or suggested changes to priority value(s) for one or more cells.

As illustrated, the CHO evaluation period 1926 ends in the event that the UE 1902 determines that the CHO condition(s) of an applicable CHO event of an applicable CHO configuration have been met. With respect to embodiments using predicted L3 measurements, it may be considered that such a CHO condition is met in various possible cases.

In a first case, the CHO condition is considered met either where actual L3 measurements satisfy the CHO condition, or when predicted L3 measurements satisfy the CHO condition and have a corresponding confidence level that is greater than threshold.

In a second case, the CHO condition is considered met when both actual L3 measurements and predicted L3 measurements satisfy the CHO condition, and when the predicted L3 measurements have a corresponding confidence level that is greater than a threshold.

In a third case, the CHO condition is considered to be met when predicted L3 measurements satisfy the CHO condition and have a corresponding confidence level that is greater than threshold (e.g., without reference one way or another to actual L3 measurements).

Note that an additional case corresponds to considering the CHO condition to be met when actual L3 measurements satisfy the CHO condition (e.g., without reference one way or another to predicted L3 measurements) It may be that UE behavior as to which of these cases for considering a CHO condition to be met may be configured at the UE 1902 by the source base station 1904 (e.g., via RRC signaling).

In cases where more than one target cell (e.g., each of the first target cell 1906 and the second target cell 1908) satisfies the CHO condition, the UE may select one of the target cells according to configured priority values for these target cells. With respect to such mechanisms, note that the source base station 1904 can cause a change of priority of a target cell, using DL signaling (e.g., a MAC-CE or DCI).

The flow diagram 1900 illustrates a case where the UE 1902 determines that the second target cell 1908 meets the CHO condition(s) for the applicable CHO event(s) of the CHO configuration 1918 and thus performs a HO thereto. As illustrated, the UE 1902 performs a RACH procedure 1930 with the second target cell 1908 to attach to the second target cell 1908. Once the HO to the second target cell 1908 is complete, the UE 1902 sends the second target cell 1908 a CHO complete message 1932 (e.g., an RRCReconfigurationComplete message) indicating to the network (through the second target cell 1908) that the CHO has occurred.

### Embodiments of LTM Failure Handling With Respect to CHO Procedures Using Predicted Measurements

If a CHO execution has failed (for example due to RACH failure with the selected target cell), the UE may perform cell selection procedures in a manner that considers the (potential) use of information provided in the CHO configuration 1918. For example, if configured cell(s) are suitable, the UE may choose a target cell via the following prioritization rules. First, the UE may follow any configured priority values (if configured). Then the UE may select a cell based on whether the relevant CHO condition is met with actual measurements of that cell. Finally, the UE may select a cell according to a confidence level (for predicted measurements).

Note that these prioritization rules are given by way of example and not by way of limitation. It is anticipated that prioritization rules for this situation could vary based on UE implementation.

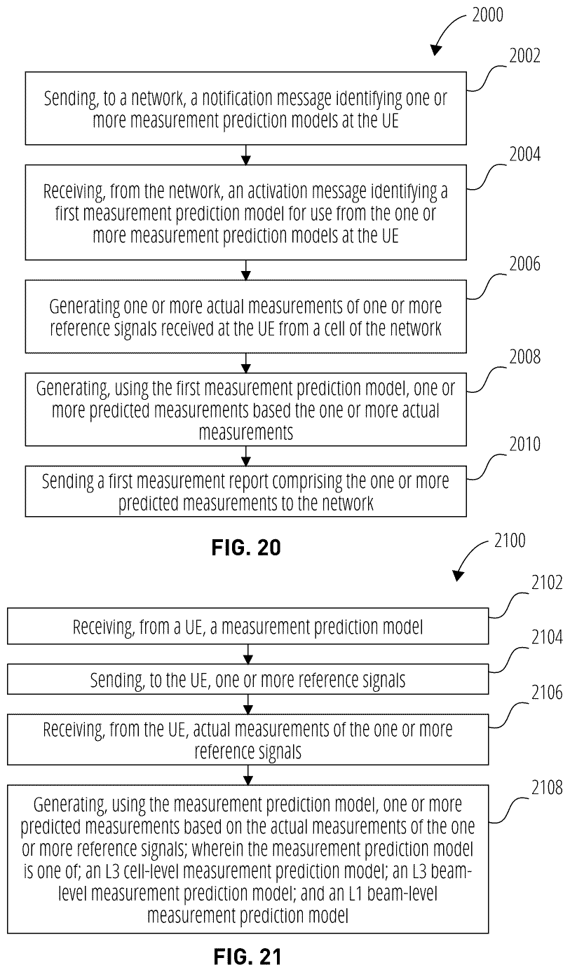

FIG. 20 illustrates a method 2000 of a UE, according to embodiments discussed herein. The method 2000 includes sending 2002, to a network, a notification message identifying one or more measurement prediction models at the UE. The method 2000 further includes receiving 2004, from the network, an activation message identifying a first measurement prediction model for use from the one or more measurement prediction models at the UE. The method 2000 further includes generating 2006 one or more actual measurements of one or more reference signals received at the UE from a cell of the network. The method 2000 further includes generating 2008, using the first measurement prediction model, one or more predicted measurements based the one or more actual measurements. The method 2000 further includes sending 2010 a first measurement report comprising the one or more predicted measurements to the network.

In some embodiments of the method 2000, the one or more predicted measurements comprise one or more predicted L3 cell-level measurements.

In some such embodiments, the one or more actual measurements comprise one or more actual L3 cell-level measurements for the one or more reference signals received at the UE; and the one or more predicted L3 cell-level measurements are generated using the first measurement prediction model by providing the one or more actual L3 cell-level measurements to the first measurement prediction model.

In some such embodiments, the one or more actual measurements comprise one or more actual L1 beam-level measurements of the one or more reference signals received at the UE; and the one or more predicted L3 cell-level measurements are generated using the first measurement prediction model by: providing the one or more actual L1 beam-level measurements to the first measurement prediction model to generate one or more predicted L1 beam-level measurements; and performing linear averaging and L3 filtering over the one or more actual L1 beam-level measurements and the one or more predicted L1 beam level-measurements. In some of these cases, L3 filter coefficients used for the L3 filtering are generated by the measurement prediction model.

In some such embodiments, the one or more actual measurements comprise one or more actual L1 beam-level measurements of the one or more reference signals received at the UE; and the one or more predicted L3 cell-level measurements are generated using the first measurement prediction model by: performing linear averaging over the one or more actual L1 beam-level measurements; and providing one or more actual linear averaging results of the linear averaging and a set of configured L3 filter coefficients to the first measurement prediction model.

In some such embodiments, the one or more actual measurements comprise one or more actual L1 beam-level measurements of the one or more reference signals received at the UE; and the one or more predicted L3 cell-level measurements are generated using the first measurement prediction model by providing the one or more actual L1 beam level measurements and a set of configured L3 filter coefficients to the first measurement prediction model.

In some such embodiments, the one or more predicted L3 cell-level measurements are for a neighbor cell to the cell; and the generating, using the first measurement prediction model, one or more predicted L3 cell-level measurements is further based on correlation information for the neighbor cell.

In some such embodiments, the method 2000 further includes receiving, from the network, configuration information identifying a frequency, and wherein the one or more predicted L3 cell-level measurements are for the frequency.

In some such embodiments, the method 2000 further includes receiving, from the network, configuration information identifying a condition for generating the one or more predicted L3 cell-level measurements, and wherein the one or more predicted L3 cell-level measurements are generated in response to determining, at the UE, that the condition has been met.

In some such embodiments, the method 2000 further includes receiving, from the network, configuration information identifying the cell, and wherein the UE selects to generate the one or more predicted L3 cell-level measurements based on the identification of the cell in the configuration information.

In some embodiments of the method 2000, the one or more predicted measurements comprise one or more predicted L3 beam-level measurements.

In some such embodiments, the one or more actual measurements comprise one or more actual L3 beam-level measurements of the one or more reference signals received at the UE; and the one or more predicted L3 beam-level measurements are generated using the first measurement prediction model by providing the one or more actual L3 beam-level measurements to the first measurement prediction model.

In some such embodiments, the one or more actual measurements comprise one or more actual L1 beam-level measurements of the one or more reference signals received at the UE; and the one or more predicted L3 beam-level measurements are generated using the first measurement prediction model by: providing the one or more actual L1 beam-level measurements to the first measurement prediction model to generate one or more predicted L1 beam-level measurements; and performing L3 filtering over the one or more actual L1 beam-level measurements and the one or more predicted L1 beam level-measurements.

In some such embodiments, the one or more actual measurements comprise one or more actual L1 beam-level measurements of the one or more reference signals received at the UE; and the one or more predicted L3 beam-level measurements are generated using the first measurement prediction model by providing the one or more actual L1 beam-level measurements to the first measurement prediction model.

In some such embodiments, the one or more reference signals are received on one or more beams; the one or more predicted L3 beam-level measurements are for a neighbor beam to the one or more beams that is not part of the one or more beams; and the generating, using the first measurement prediction model, one or more predicted L3 beam-level measurements is further based on statistical information of a channel between the UE and the cell.

In some such embodiments, the method 2000 further includes receiving, from the network, configuration information identifying a beam, and wherein the one or more predicted L3 beam-level measurements are for the beam.

In some such embodiments, the method 2000 further includes receiving, from the network, configuration information identifying a condition for generating the one or more predicted L3 beam-level measurements, and wherein the one or more predicted L3 beam-level measurements are generated in response to determining, at the UE, that the condition has been met.

In some such embodiments, the method 2000 further includes receiving, from the network, configuration information identifying a beam, and wherein the UE selects to include a predicted L3 cell-level measurement for the beam in the one or more predicted L3 beam-level measurements based on the identification of the beam in the configuration information.

In some embodiments of the method 2000, the one or more predicted measurements comprise one or more predicted L1 beam-level measurements.

In some such embodiments, the one or more actual measurements comprise one or more actual L1 beam-level measurements for the one or more reference signals received at the UE; and the one or more predicted L1 beam-level measurements are generated using the first measurement prediction model by providing the one or more actual L1 beam-level measurements to the first measurement prediction model.

In some such embodiments, the one or more reference signals are received on one or more beams; the one or more predicted L1 beam-level measurements are for a neighbor beam to the one or more beams that is not part of the one or more beams.

In some such embodiments, the method 2000 further includes receiving, from the network, configuration information identifying a beam, and wherein the one or more predicted L1 beam-level measurements are for the beam.

In some such embodiments, the method 2000 further includes receiving, from the network, configuration information identifying a condition for generating the one or more predicted L1 beam-level measurements, and wherein the one or more predicted L1 beam-level measurements are generated in response to determining, at the UE, that the condition has been met.

In some such embodiments, the method 2000 further includes receiving, from the network, configuration information identifying a beam, and wherein the UE selects to include a predicted L1 cell-level measurement for the beam in the one or more predicted L1 beam-level measurements based on the identification of the beam in the configuration information.

In some embodiments, the method 2000 further includes receiving, from the network, configuration information indicating a predicted measurement periodicity and an actual measurement periodicity; and sending a second measurement report comprising the one or more actual measurements to the UE according to the actual measurement periodicity; wherein the first measurement report comprising the one or more predicted measurements is sent according to the predicted measurement periodicity.

In some embodiments of the method 2000, the sending of the first measurement report comprising the one or more predicted measurements to the network is triggered by the one or more predicted measurements.

In some embodiments of the method 2000, the sending of the first measurement report comprising the one or more predicted measurements to the network is triggered by the actual measurements of the one or more reference signals.

In some embodiments of the method 2000, the first measurement report further comprises an indication that the one or more predicted measurements are predictive measurements.

In some embodiments of the method 2000, the first measurement report further comprises the one or more actual measurements of the one or more reference signals.

In some embodiments of the method 2000, the notification message further comprises one or more of: a predicted optimal L3 filter coefficient; a predicted optimal measurement report event type; a predicted optimal TTT for a measurement report event; a predicted optimal threshold for the measurement report event; a suggested cell for actual measurement; a suggested beam for a first actual measurement of the one or more actual measurements; and a suggested T304 timer value.

In some embodiments, the method 2000 further includes sending, to the network, assistance information comprising one or more of: nearby base station deployment geometry; first statistics corresponding to temporal correlation; second statistics corresponding to inter-cell correlation; and third statistics corresponding to inter-beam correlation.

FIG. 21 illustrates a method 2100 of a RAN, according to embodiments disclosed herein. The method 2100 includes receiving 2102, from a UE, a measurement prediction model. The method 2100 further includes sending 2104, to the UE, one or more reference signals. The method 2100 further includes receiving 2106, from the UE, actual measurements of the one or more reference signals. The method 2100 further includes generating 2108, using the measurement prediction model, one or more predicted measurements based on the actual measurements of the one or more reference signals; wherein the measurement prediction model is one of: an L3 cell-level measurement prediction model; an L3 beam-level measurement prediction model; and an L1 beam-level measurement prediction model.

In some embodiments, the method 2100 further includes sending, to the UE, configuration information to be used by the UE to re-train the measurement prediction model.

In some embodiments, the method 2100 further includes receiving, from the UE, a timestamp at which the actual measurements were generated.

In some embodiments, the method 2100 further includes receiving, from the UE, a position of the UE and a moving orientation of the UE.

In some embodiments, the method 2100 further includes receiving, from the UE, a change to a moving orientation of the UE.

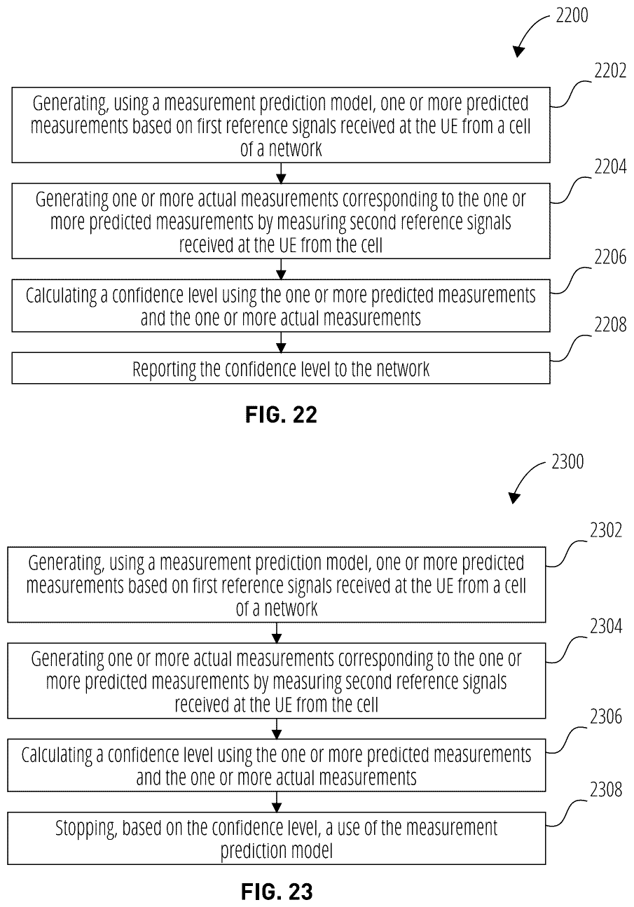

FIG. 22 illustrates a method 2200 of a UE, according to embodiments discussed herein. The method 2200 includes generating 2202, using a measurement prediction model, one or more predicted measurements based on first reference signals received at the UE from a cell of a network. The method 2200 further includes generating 2204 one or more actual measurements corresponding to the one or more predicted measurements by measuring second reference signals received at the UE from the cell. The 2200 further includes calculating 2206 a confidence level using the one or more predicted measurements and the one or more actual measurements. The method 2200 further includes reporting 2208 the confidence level to the network.

In some embodiments of the method 2200, the calculating the confidence level comprises determining an MSE between the predicted measurements and the actual measurements.

In some embodiments, the method 2200 further includes receiving, from the network, an instructions to stop using the measurement prediction model.

In some embodiments, the method 2200 further includes reporting, to the network, a first timestamp at which the predicted measurements were generated and a second timestamp at which the actual measurements were generated.

In some embodiments, the method 2200 further includes reporting, to the network, a position of the UE and a moving orientation of the UE.

FIG. 23 illustrates a method 2300 of a UE, according to embodiments discussed herein. The method 2300 includes generating 2302, using a measurement prediction model, one or more predicted measurements based on first reference signals received at the UE from a cell of a network. The method 2300 further includes generating 2304, one or more actual measurements corresponding to the one or more predicted measurements by measuring second reference signals received at the UE from the cell. The method 2300 further includes calculating 2306 a confidence level using the one or more predicted measurements and the one or more actual measurements. The method 2300 further includes stopping 2308, based on the confidence level, a use of the measurement prediction model.

In some embodiments of the method 2300, the calculating the confidence level comprises determining an MSE between the predicted measurements and the actual measurements.

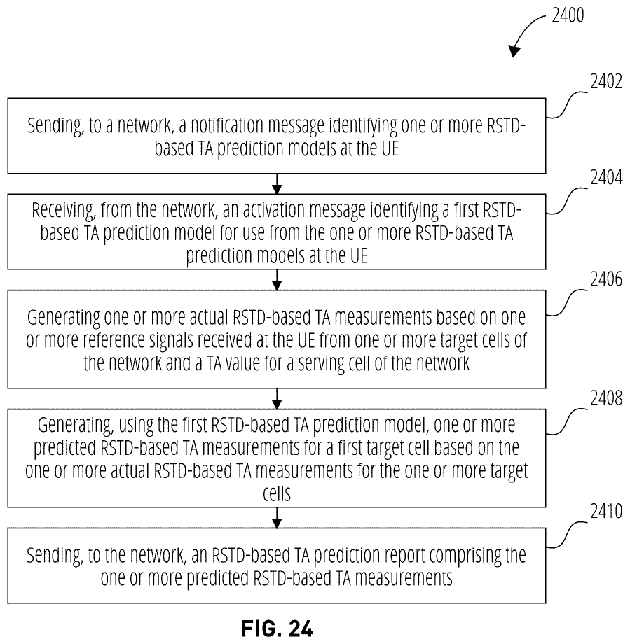

FIG. 24 illustrates a method 2400 of a UE, according to embodiments discussed herein. The method 2400 includes sending 2402, to a network, a notification message identifying one or more RSTD-based TA prediction models at the UE. The method 2400 further includes receiving 2404, from the network, an activation message identifying a first RSTD-based TA prediction model for use from the one or more RSTD-based TA prediction models at the UE. The 2400 further includes generating 2406 one or more actual RSTD-based TA measurements based on one or more reference signals received at the UE from one or more target cells of the network and a TA value for a serving cell of the network. The method 2400 further includes generating 2408, using the first RSTD-based TA prediction model, one or more predicted RSTD-based TA measurements for a first target cell based on the one or more actual RSTD-based TA measurements for the one or more target cells. The method 2400 further includes sending 2410, to the network, an RSTD-based TA prediction report comprising the one or more predicted RSTD-based TA measurements.

In some embodiments of the method 2400, the one or more reference signals are reference signals of the first target cell.

In some embodiments of the method 2400, the one or more reference signals are reference signals that were not transmitted by the first target cell.

In some embodiments of the method 2400, the RSTD-based TA prediction report further includes a validity time for the one or more predicted RSTD-based TA measurements for the first target cell.

In some embodiments of the method 2400, the RSTD-based TA prediction report further includes a confidence level for the one or more predicted RSTD-based TA measurements for the first target cell.

In some embodiments, the method 2400 further includes receiving, from the network, configuration information indicating a predicted RSTD-based TA measurement periodicity and an actual RSTD-based TA measurement periodicity; and sending an actual RSTD-based TA report comprising the one or more actual RSTD-based TA measurements for the first target cell to the UE according to the actual RSTD-based TA measurement periodicity; wherein the RSTD-based TA prediction report comprising the one or more predicted RSTD-based TA measurements for the first target cell is sent according to the predicted RSTD-based TA measurement periodicity.

In some embodiments of the method 2400, the sending of the RSTD-based TA prediction report comprising the one or more predicted RSTD-based TA measurements to the network is triggered by a determination by the UE that a first predicted RSTD-based TA measurement of the one or more predicted RSTD-based TA measurements for the first target cell and a prior predicted RSTD-based TA measurement for the first target cell differ by at least threshold.

In some embodiments of the method 2400, the RSTD-based TA prediction report further comprises an indication that the one or more predicted RSTD-based TA measurements are predictive RSTD-based TA measurements.

In some embodiments of the method 2400, the RSTD-based TA prediction report further comprises the one or more actual measurements of the one or more reference signals.

In some embodiments of the method 2400, the one or more predicted RSTD-based TA measurements are sorted in the RSTD-based TA prediction report first based on Layer 3 (L3) measurements for corresponding cells, then based on confidence levels associated with the one or more predicted RSTD-based TA measurements.

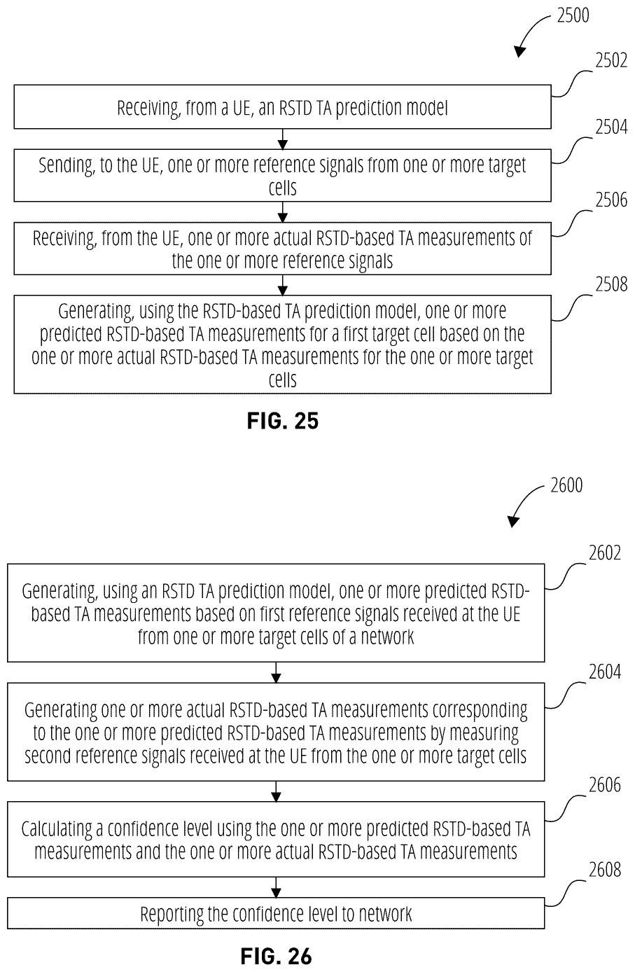

FIG. 25 illustrates a method 2500 of a RAN, according to embodiments discussed herein. The method 2500 includes receiving 2502, from a UE, an RSTD TA prediction model. The method 2500 further includes sending 2504, to the UE, one or more reference signals from one or more target cells. The method 2500 further includes receiving 2506, from the UE, one or more actual RSTD-based TA measurements of the one or more reference signals. The method 2500 further includes generating 2508, using the RSTD-based TA prediction model, one or more predicted RSTD-based TA measurements for a first target cell based on the one or more actual RSTD-based TA measurements for the one or more target cells.

In some embodiments, the method 2500 further includes sending, to the UE, configuration information to be used by the UE to re-train the measurement prediction model.

In some embodiments, the method 2500 further includes receiving, from the UE, a timestamp at which the one or more actual RSTD-based TA measurements were generated.

In some embodiments, the method 2500 further includes receiving, from the UE, a position of the UE and a moving orientation of the UE.

In some embodiments, the method 2500 further includes receiving, from the UE, a change to a moving orientation of the UE.

FIG. 26 illustrates a method 2600 of a UE, according to embodiments discussed herein. The method 2600 includes generating 2602, using a RSTD TA prediction model, one or more predicted RSTD-based TA measurements based on first reference signals received at the UE from one or more target cells of a network. The method 2600 further includes generating 2604 one or more actual RSTD-based TA measurements corresponding to the one or more predicted RSTD-based TA measurements by measuring second reference signals received at the UE from the one or more target cells. The method 2600 further includes calculating 2606 a confidence level using the one or more predicted RSTD-based TA measurements and the one or more actual RSTD-based TA measurements. The method 2600 further includes reporting 2608 the confidence level to network.

In some embodiments of the method 2600, the calculating the confidence level comprises determining an MSE between the predicted RSTD-based TA measurements and the actual RSTD-based TA measurements.

In some embodiments, the method 2600 further includes receiving, from the network, an instructions to stop using the RSTD-based TA prediction model.

In some embodiments, the method 2600 further includes reporting, to the network, a first timestamp at which the predicted RSTD-based TA measurements were generated and a second timestamp at which the actual RSTD-based TA measurements were generated.

In some embodiments, the method 2600 further includes reporting, to the network, a position of the UE and a moving orientation of the UE.

In some embodiments, the method 2600 further includes receiving, from the UE, a change to a moving orientation of the UE.

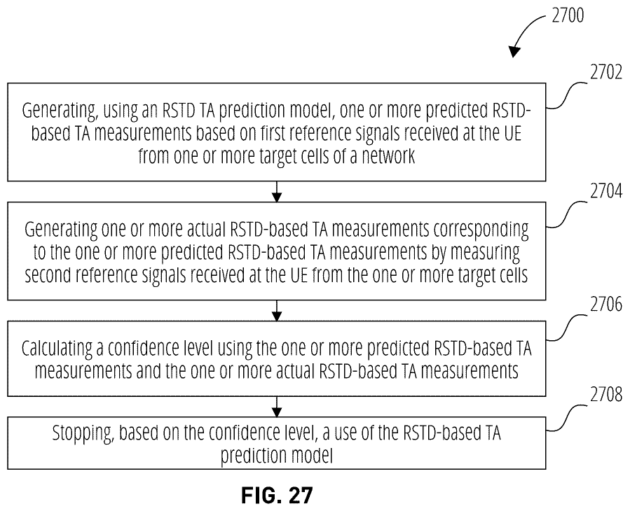

FIG. 27 illustrates a method 2700 of a UE, according to embodiments discussed herein. The 2700 includes generating 2702, using an RSTD TA prediction model, one or more predicted RSTD-based TA measurements based on first reference signals received at the UE from one or more target cells of a network. The method 2700 further includes generating 2704 one or more actual RSTD-based TA measurements corresponding to the one or more predicted RSTD-based TA measurements by measuring second reference signals received at the UE from the one or more target cells. The method 2700 further includes calculating 2706 a confidence level using the one or more predicted RSTD-based TA measurements and the one or more actual RSTD-based TA measurements. The 2700 further includes stopping 2708, based on the confidence level, a use of the RSTD-based TA prediction model.

In some embodiments of the method 2700, the calculating the confidence level comprises determining an MSE between the predicted RSTD-based TA measurements and the actual RSTD-based TA measurements.

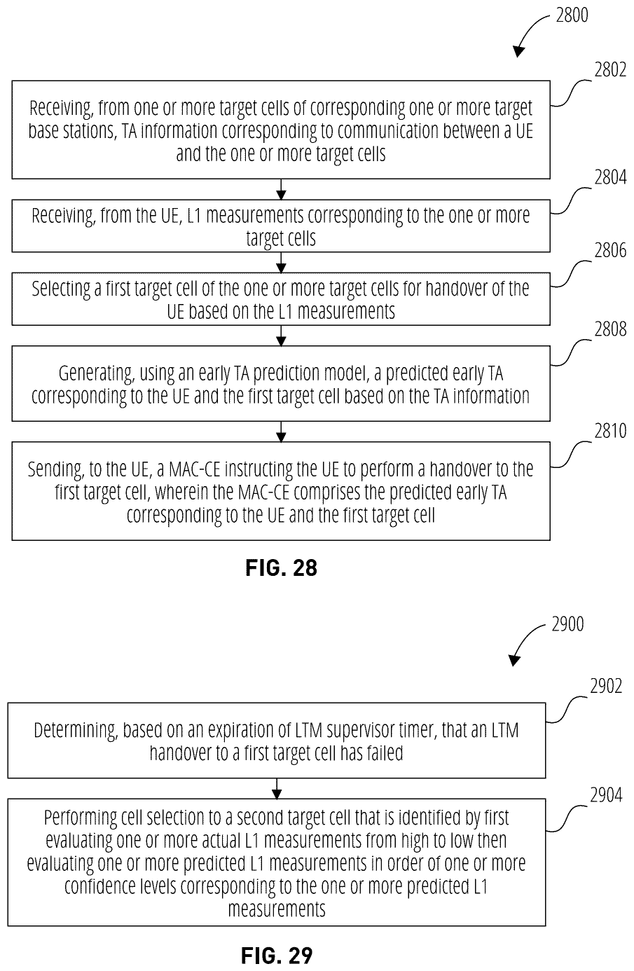

FIG. 28 illustrates a method 2800 of a source base station of a RAN, according to embodiments discussed herein. The method 2800 includes receiving 2802 from one or more target cells of corresponding one or more target base stations, TA information corresponding to communication between a UE and the one or more target cells. The method 2800 further includes receiving 2804, from the UE, L1 measurements corresponding to the one or more target cells. The method 2800 further includes selecting 2806 a first target cell of the one or more target cells for handover of the UE based on the L1 measurements. The method 2800 further includes generating 2808, using an early TA prediction model, a predicted early TA corresponding to the UE and the first target cell based on the TA information. The method 2800 further includes sending 2810, to the UE, a MAC-CE instructing the UE to perform a handover to the first target cell, wherein the MAC-CE comprises the predicted early TA corresponding to the UE and the first target cell.

In some embodiments, the method 2800 further includes sending, to the UE, an applicability condition request corresponding to an applicability condition for selecting the early TA prediction model from one or more early TA prediction models at the RAN; receiving, from the UE, an applicability condition response that indicates a value for the applicability condition; and selecting, the early TA prediction model from the one or more early TA prediction models based on the value of the applicability condition. In some such embodiments, the applicability condition comprises a threshold for a speed of the UE, the applicability condition request comprises a request for a value of the speed of the UE, and the applicability response comprises the value for the speed of the UE.

In some embodiments of the method 2800, the TA information comprises a TA value and a timestamp corresponding to the TA value.

FIG. 29 illustrates a method 2900 of a UE, according to embodiments discussed herein. The method 2900 includes determining 2902, based on an expiration of an LTM supervisor time, that an LTM handover to a first target cell has failed. The method 2900 further includes performing 2904 cell selection to a second target cell that is identified by first evaluating one or more actual L1 measurements from high to low and then evaluating one or more predicted L1 measurements in order of one or more confidence levels corresponding to the one or more predicted L1 measurements.

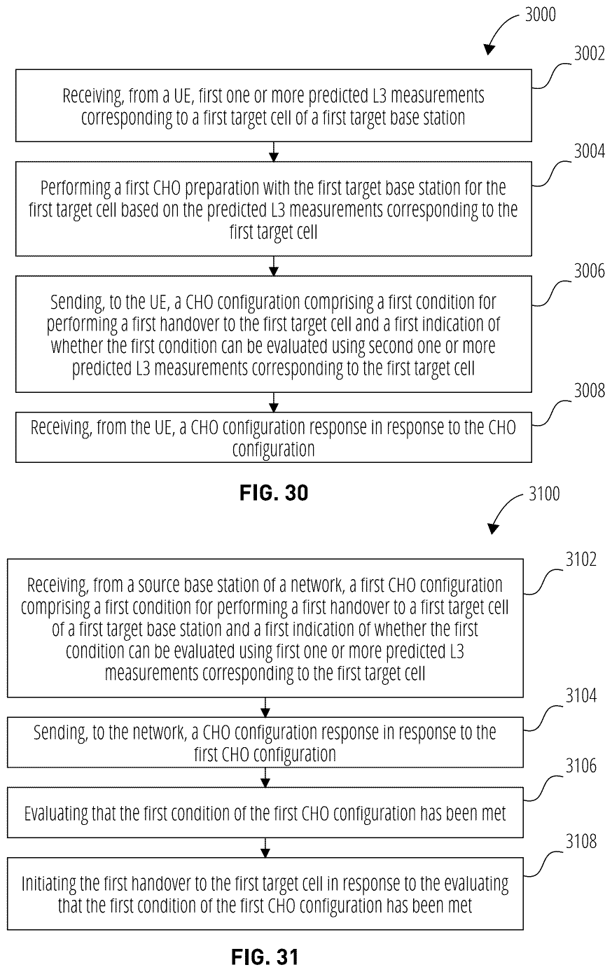

FIG. 30 illustrates a method 3000 of a source base station of a RAN, according to embodiments discussed herein. The method 3000 includes receiving 3002, from a UE, first one or more predicted L3 measurements corresponding to a first target cell of a first target base station. The method 3000 further includes performing 3004 a first CHO preparation with the first target base station for the first target cell based on the predicted L3 measurements corresponding to the first target cell. The method 3000 further includes sending 3006, to the UE, a CHO configuration comprising a first condition for performing a first handover to the first target cell and a first indication of whether the first condition can be evaluated using second one or more predicted L3 measurements corresponding to the first target cell. The method 3000 further includes receiving 3008, from the UE, a CHO configuration response in response to the CHO configuration.

In some embodiments of the method 3000, the CHO configuration includes a confidence level threshold for using the second one or more predicted L3 measurements to evaluate the first condition.

In some embodiments, the method 3000 further includes receiving, from the UE, third one or more predicted Layer 3 (L3) measurements corresponding to a second target cell of a second target base station; and performing a second CHO preparation with the second target base station for the second target cell based on the third one or more predicted L3 measurements corresponding to the second target cell; wherein the CHO configuration further comprises a second condition for performing a second handover to the second target cell and a second indication of whether the second condition can be evaluated using fourth one or more predicted L3 measurements corresponding to the second target cell.

In some embodiments of the method 3000, the CHO configuration further comprises a second condition for performing the first handover to the first target cell and a second indication of whether the second condition can be evaluated using the second one or more predicted L3 measurements.

In some embodiments of the method 3000, the CHO configuration further comprises a priority value of the first target cell.

In some embodiments of the method 3000, the CHO configuration response includes a suggested change to a target cell list used by the RAN.

In some embodiments of the method 3000, the CHO configuration response includes updates to the first one or more predicted L3 measurements corresponding to the first target cell.

In some embodiments of the method 3000, the CHO configuration response includes a prediction error metric for the first one or more predicted L3 measurements.

In some embodiments of the method 3000, the CHO configuration response includes a suggested change to the CHO configuration. In some such embodiments, the suggested change to the CHO configuration comprises one or more of a suggested change to a CHO event type, a suggested change to a threshold for a CHO event, and a suggested change to a TTT.

In some embodiments of the method 3000, the CHO configuration response includes a suggested priority value change for a priority value of the first target cell.

In some embodiments, the method 3000 further includes sending, to the UE, an update to the CHO configuration based on information received from the UE in the CHO configuration response.

In some embodiments, the method 3000 further includes receiving, from the UE, a UAI message comprising a suggested change to a target cell list used by the RAN.

In some embodiments, the method 3000 further includes receiving, from the UE, a UAI message comprising a suggested target cell for an execution of a non-conditional handover.

In some embodiments, the method 3000 further includes receiving, from the UE, a UAI message comprising a suggested priority value change for a priority value of the first target cell.

FIG. 31 illustrates a method 3100 of a UE, according to embodiments disclosed herein. The method 3100 includes receiving 3102, from a source base station of a network, a first CHO configuration comprising a first condition for performing a first handover to a first target cell of a first target base station and a first indication of whether the first condition can be evaluated using first one or more predicted L3 measurements corresponding to the first target cell. The method 3100 further includes sending 3104, to the network, a CHO configuration response in response to the first CHO configuration. The method 3100 further includes evaluating 3106 that the first condition of the first CHO configuration has been met. The method 3100 further includes initiating 3108 the first handover to the first target cell in response to the evaluating that the first condition of the first CHO configuration has been met.

In some embodiments, the method 3100 further includes generating second one or more predicted L3 measurements corresponding to the first target cell; and sending, to the network, the second one or more predicted L3 measurements corresponding to the first target cell prior to receiving the first CHO configuration from the network.

In some embodiments of the method 3100, the CHO configuration response includes updates to the second one or more predicted L3 measurements corresponding to the first target cell.

In some embodiments of the method 3100, the CHO configuration response includes a prediction error metric for the second one or more predicted L3 measurements.

In some embodiments of the method 3100, the first CHO configuration includes a confidence level threshold for using the first one or more predicted L3 measurements to evaluate the first condition.

In some embodiments of the method 3100, the first CHO configuration further comprises a second condition for performing a second handover to a second target cell and a second indication of whether the second condition can be evaluated using second one or more predicted L3 measurements corresponding to the second target cell.

In some embodiments of the method 3100, the first CHO configuration further comprises a second condition for performing the first handover to the first target cell and a second indication of whether the second condition can be evaluated using the first one or more predicted L3 measurements.

In some embodiments of the method 3100, the first CHO configuration further comprises a priority value of the first target cell.

In some embodiments of the method 3100, the CHO configuration response includes a suggested change to a target cell list used by the network.

In some embodiments of the method 3100, the CHO configuration response includes a suggested change to the first CHO configuration. In some such embodiments, the suggested change to the CHO configuration comprises one or more of a suggested change to a CHO event type, a suggested change to a threshold of a CHO event, and a suggested change to a TTT.

In some embodiments of the method 3100, the CHO configuration response includes a suggested priority value change for a priority value of the first target cell.

In some embodiments, the method 3100 further includes receiving, from the network, an update to the first CHO configuration.

In some embodiments, the method 3100 further includes sending, to the network, a UAI message comprising a suggested change to a target cell list used by the RAN.

In some embodiments, the method 3100 further includes sending, to the network, a UAI message comprising a suggested target cell for an execution of a non-conditional handover.

In some embodiments, the method 3100 further includes sending, to the network, a UAI message comprising a suggested priority value change for a priority value of the first target cell.

In some embodiments of the method 3100, the evaluating that the first condition of the first CHO configuration has been met comprises at least one of: determining that one or more actual L3 measurements of the first target cell satisfy the condition; and determining that the first one or more predicted L3 measurements satisfy the condition.

In some embodiments of the method 3100, the evaluating that the first condition of the first CHO configuration has been met comprises each of: determining that one or more actual L3 measurements of the first target cell satisfy the condition; and determining that the first one or more predicted L3 measurements satisfy the condition.

In some embodiments of the method 3100, the first handover to the first target cell is further initiated in response to a comparison of a first priority value for the first target cell to a second priority value for a second target cell of a second target base station for which a second condition of a second CHO configuration has been met.

In some embodiments, the method 3100 further includes determining that the first handover to the first target cell has failed; and performing cell selection to a second target cell of a second target base station based on a configured priority value for the second target cell.

In some embodiments, the method 3100 further includes determining that the first handover to the first target cell has failed; and performing cell selection to a second target cell of a second target base station based on a determination that a second condition of a second CHO configuration for a second handover to the second target cell is met.

In some embodiments, the method 3100 further includes determining that the first handover to the first target cell has failed; and performing cell selection to a second target cell of a second target base station based on a confidence level of second one or more predicted L3 measurements corresponding to the second target cell.

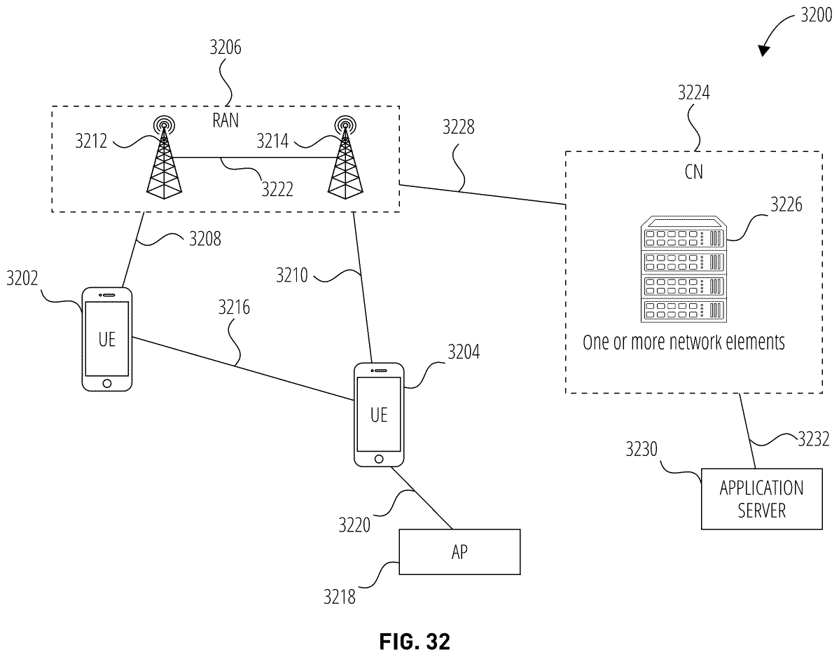

FIG. 32 illustrates an example architecture of a wireless communication system 3200, according to embodiments disclosed herein. The following description is provided for an example wireless communication system 3200 that operates in conjunction with the LTE system standards and/or 5G or NR system standards as provided by 3GPP technical specifications.

As shown by FIG. 32, the wireless communication system 3200 includes UE 3202 and UE 3204 (although any number of UEs may be used). In this example, the UE 3202 and the UE 3204 are illustrated as smartphones (e.g., handheld touchscreen mobile computing devices connectable to one or more cellular networks), but may also comprise any mobile or non-mobile computing device configured for wireless communication.

The UE 3202 and UE 3204 may be configured to communicatively couple with a RAN 3206. In embodiments, the RAN 3206 may be NG-RAN, E-UTRAN, etc. The UE 3202 and UE 3204 utilize connections (or channels) (shown as connection 3208 and connection 3210, respectively) with the RAN 3206, each of which comprises a physical communications interface. The RAN 3206 can include one or more base stations (such as base station 3212 and base station 3214) that enable the connection 3208 and connection 3210.

In this example, the connection 3208 and connection 3210 are air interfaces to enable such communicative coupling, and may be consistent with RAT(s) used by the RAN 3206, such as, for example, an LTE and/or NR.

In some embodiments, the UE 3202 and UE 3204 may also directly exchange communication data via a sidelink interface 3216. The UE 3204 is shown to be configured to access an access point (shown as AP 3218) via connection 3220. By way of example, the connection 3220 can comprise a local wireless connection, such as a connection consistent with any IEEE 802.11 protocol, wherein the AP 3218 may comprise a Wi-Fi® router. In this example, the AP 3218 may be connected to another network (for example, the Internet) without going through a CN 3224.

In embodiments, the UE 3202 and UE 3204 can be configured to communicate using orthogonal frequency division multiplexing (OFDM) communication signals with each other or with the base station 3212 and/or the base station 3214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 3212 or base station 3214 may be implemented as one or more software entities running on server computers as part of a virtual network. In addition, or in other embodiments, the base station 3212 or base station 3214 may be configured to communicate with one another via interface 3222. In embodiments where the wireless communication system 3200 is an LTE system (e.g., when the CN 3224 is an EPC), the interface 3222 may be an X2 interface. The X2 interface may be defined between two or more base stations (e.g., two or more eNBs and the like) that connect to an EPC, and/or between two eNBs connecting to the EPC. In embodiments where the wireless communication system 3200 is an NR system (e.g., when CN 3224 is a 5GC), the interface 3222 may be an Xn interface. The Xn interface is defined between two or more base stations (e.g., two or more gNBs and the like) that connect to 5GC, between a base station 3212 (e.g., a gNB) connecting to 5GC and an eNB, and/or between two eNBs connecting to 5GC (e.g., CN 3224).

The RAN 3206 is shown to be communicatively coupled to the CN 3224. The CN 3224 may comprise one or more network elements 3226, which are configured to offer various data and telecommunications services to customers/subscribers (e.g., users of UE 3202 and UE 3204) who are connected to the CN 3224 via the RAN 3206. The components of the CN 3224 may be implemented in one physical device or separate physical devices including components to read and execute instructions from a machine-readable or computer-readable medium (e.g., a non-transitory machine-readable storage medium).

In embodiments, the CN 3224 may be an EPC, and the RAN 3206 may be connected with the CN 3224 via an S1 interface 3228. In embodiments, the S1 interface 3228 may be split into two parts, an S1 user plane (S1-U) interface, which carries traffic data between the base station 3212 or base station 3214 and a serving gateway (S-GW), and the S1-MME interface, which is a signaling interface between the base station 3212 or base station 3214 and mobility management entities (MMEs).

In embodiments, the CN 3224 may be a 5GC, and the RAN 3206 may be connected with the CN 3224 via an NG interface 3228. In embodiments, the NG interface 3228 may be split into two parts, an NG user plane (NG-U) interface, which carries traffic data between the base station 3212 or base station 3214 and a user plane function (UPF), and the S1 control plane (NG-C) interface, which is a signaling interface between the base station 3212 or base station 3214 and access and mobility management functions (AMFs).

Generally, an application server 3230 may be an element offering applications that use internet protocol (IP) bearer resources with the CN 3224 (e.g., packet switched data services). The application server 3230 can also be configured to support one or more communication services (e.g., VoIP sessions, group communication sessions, etc.) for the UE 3202 and UE 3204 via the CN 3224. The application server 3230 may communicate with the CN 3224 through an IP communications interface 3232.

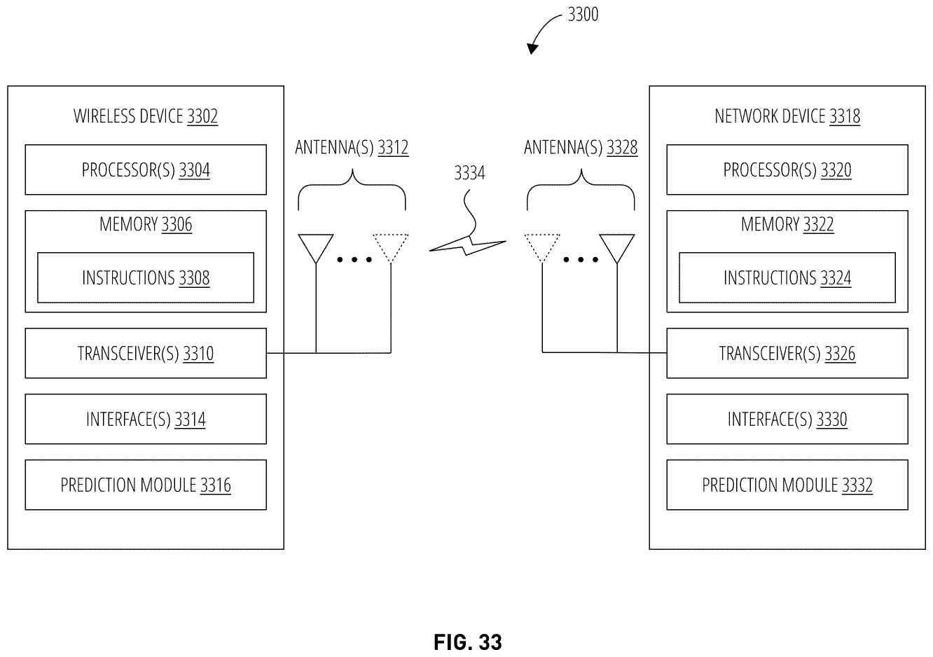

FIG. 33 illustrates a system 3300 for performing signaling 3334 between a wireless device 3302 and a network device 3318, according to embodiments disclosed herein. The system 3300 may be a portion of a wireless communications system as herein described. The wireless device 3302 may be, for example, a UE of a wireless communication system. The network device 3318 may be, for example, a base station (e.g., an eNB or a gNB) of a wireless communication system.

The wireless device 3302 may include one or more processor(s) 3304. The processor(s) 3304 may execute instructions such that various operations of the wireless device 3302 are performed, as described herein. The processor(s) 3304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 3302 may include a memory 3306. The memory 3306 may be a non-transitory computer-readable storage medium that stores instructions 3308 (which may include, for example, the instructions being executed by the processor(s) 3304). The instructions 3308 may also be referred to as program code or a computer program. The memory 3306 may also store data used by, and results computed by, the processor(s) 3304.

The wireless device 3302 may include one or more transceiver(s) 3310 that may include radio frequency (RF) transmitter circuitry and/or receiver circuitry that use the antenna(s) 3312 of the wireless device 3302 to facilitate signaling (e.g., the signaling 3334) to and/or from the wireless device 3302 with other devices (e.g., the network device 3318) according to corresponding RATs.

The wireless device 3302 may include one or more antenna(s) 3312 (e.g., one, two, four, or more). For embodiments with multiple antenna(s) 3312, the wireless device 3302 may leverage the spatial diversity of such multiple antenna(s) 3312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 3302 may be accomplished according to precoding (or digital beamforming) that is applied at the wireless device 3302 that multiplexes the data streams across the antenna(s) 3312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 3302 may implement analog beamforming techniques, whereby phases of the signals sent by the antenna(s) 3312 are relatively adjusted such that the (joint) transmission of the antenna(s) 3312 can be directed (this is sometimes referred to as beam steering).

The wireless device 3302 may include one or more interface(s) 3314. The interface(s) 3314 may be used to provide input to or output from the wireless device 3302. For example, a wireless device 3302 that is a UE may include interface(s) 3314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 3310/antenna(s) 3312 already described) that allow for communication between the UE and other devices and may operate according to known protocols (e.g., Wi-Fi®, Bluetooth®, and the like).

The wireless device 3302 may include a prediction module 3316. The prediction module 3316 may be implemented via hardware, software, or combinations thereof. For example, the prediction module 3316 may be implemented as a processor, circuit, and/or instructions 3308 stored in the memory 3306 and executed by the processor(s) 3304. In some examples, the prediction module 3316 may be integrated within the processor(s) 3304 and/or the transceiver(s) 3310. For example, the prediction module 3316 may be implemented by a combination of software components (e.g., executed by a DSP or a general processor) and hardware components (e.g., logic gates and circuitry) within the processor(s) 3304 or the transceiver(s) 3310.

The prediction module 3316 may be used for various aspects of the present disclosure, for example, aspects of FIG. 1 through FIG. 19. The prediction module 3316 may configured to cause the wireless device 3302 to perform UE-based functionalities corresponding to L3 beam-level measurement predictions, L3 beam-level measurement predictions, L1 measurement predictions, TA predictions, and/or the use of the same with respect to CHO, as these have been discussed herein.

The network device 3318 may include one or more processor(s) 3320. The processor(s) 3320 may execute instructions such that various operations of the network device 3318 are performed, as described herein. The processor(s) 3320 may include one or more baseband processors implemented using, for example, a CPU, a DSP, an ASIC, a controller, an FPGA device, another hardware device, a firmware device, or any combination thereof configured to perform the operations described herein.

The network device 3318 may include a memory 3322. The memory 3322 may be a non-transitory computer-readable storage medium that stores instructions 3324 (which may include, for example, the instructions being executed by the processor(s) 3320). The instructions 3324 may also be referred to as program code or a computer program. The memory 3322 may also store data used by, and results computed by, the processor(s) 3320.

The network device 3318 may include one or more transceiver(s) 3326 that may include RF transmitter circuitry and/or receiver circuitry that use the antenna(s) 3328 of the network device 3318 to facilitate signaling (e.g., the signaling 3334) to and/or from the network device 3318 with other devices (e.g., the wireless device 3302) according to corresponding RATs.

The network device 3318 may include one or more antenna(s) 3328 (e.g., one, two, four, or more). In embodiments having multiple antenna(s) 3328, the network device 3318 may perform MIMO, digital beamforming, analog beamforming, beam steering, etc., as has been described.

The network device 3318 may include one or more interface(s) 3330. The interface(s) 3330 may be used to provide input to or output from the network device 3318. For example, a network device 3318 that is a base station may include interface(s) 3330 made up of transmitters, receivers, and other circuitry (e.g., other than the transceiver(s) 3326/antenna(s) 3328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 3318 may include a prediction module 3332. The prediction module 3332 may be implemented via hardware, software, or combinations thereof. For example, the prediction module 3332 may be implemented as a processor, circuit, and/or instructions 3324 stored in the memory 3322 and executed by the processor(s) 3320. In some examples, the prediction module 3332 may be integrated within the processor(s) 3320 and/or the transceiver(s) 3326. For example, the prediction module 3332 may be implemented by a combination of software components (e.g., executed by a DSP or a general processor) and hardware components (e.g., logic gates and circuitry) within the processor(s) 3320 or the transceiver(s) 3326.

The prediction module 3332 may be used for various aspects of the present disclosure, for example, aspects of FIG. 1 to FIG. 19. The prediction module 3332 may be configured to cause the network device 3318 to perform base-station-based functionalities corresponding to L3 beam-level measurement predictions, L3 beam-level measurement predictions, L1 measurement predictions, TA predictions, and/or the use of the same with respect to CHO, as these have been discussed herein.

Embodiments contemplated herein include an apparatus comprising means to perform one or more elements of any one or more of the method 2000, the method 2200, the method 2300, the method 2400, the method 2600, the method 2700, the method 2900, and/or the method 3100. This apparatus may be, for example, an apparatus of a UE (such as a wireless device 3302 that is a UE, as described herein).

Embodiments contemplated herein include one or more non-transitory computer-readable media comprising instructions to cause an electronic device, upon execution of the instructions by one or more processors of the electronic device, to perform one or more elements of any one or more of the method 2000, the method 2200, the method 2300, the method 2400, the method 2600, the method 2700, the method 2900, and/or the method 3100. This non-transitory computer-readable media may be, for example, a memory of a UE (such as a memory 3306 of a wireless device 3302 that is a UE, as described herein).

Embodiments contemplated herein include an apparatus comprising logic, modules, or circuitry to perform one or more elements of any one or more of the method 2000, the method 2200, the method 2300, the method 2400, the method 2600, the method 2700, the method 2900, and/or the method 3100. This apparatus may be, for example, an apparatus of a UE (such as a wireless device 3302 that is a UE, as described herein).

Embodiments contemplated herein include an apparatus comprising: one or more processors and one or more computer-readable media comprising instructions that, when executed by the one or more processors, cause the one or more processors to perform one or more elements of any one or more of the method 2000, the method 2200, the method 2300, the method 2400, the method 2600, the method 2700, the method 2900, and/or the method 3100. This apparatus may be, for example, an apparatus of a UE (such as a wireless device 3302 that is a UE, as described herein).

Embodiments contemplated herein include a signal as described in or related to one or more elements of any one or more of the method 2000, the method 2200, the method 2300, the method 2400, the method 2600, the method 2700, the method 2900, and/or the method 3100.

Embodiments contemplated herein include a computer program or computer program product comprising instructions, wherein execution of the program by a processor is to cause the processor to carry out one or more elements of any one or more of the method 2000, the method 2200, the method 2300, the method 2400, the method 2600, the method 2700, the method 2900, and/or the method 3100. The processor may be a processor of a UE (such as a processor(s) 3304 of a wireless device 3302 that is a UE, as described herein). These instructions may be, for example, located in the processor and/or on a memory of the UE (such as a memory 3306 of a wireless device 3302 that is a UE, as described herein).

Embodiments contemplated herein include an apparatus comprising means to perform one or more elements of any one or more of the method 2100, the method 2500, the method 2800, and/or the method 3000. This apparatus may be, for example, an apparatus of a base station (such as a network device 3318 that is a base station, as described herein).

Embodiments contemplated herein include one or more non-transitory computer-readable media comprising instructions to cause an electronic device, upon execution of the instructions by one or more processors of the electronic device, to perform one or more elements of any one or more of the method 2100, the method 2500, the method 2800, and/or the method 3000. This non-transitory computer-readable media may be, for example, a memory of a base station (such as a memory 3322 of a network device 3318 that is a base station, as described herein).

Embodiments contemplated herein include an apparatus comprising logic, modules, or circuitry to perform one or more elements of any one or more of the method 2100, the method 2500, the method 2800, and/or the method 3000. This apparatus may be, for example, an apparatus of a base station (such as a network device 3318 that is a base station, as described herein).

Embodiments contemplated herein include an apparatus comprising: one or more processors and one or more computer-readable media comprising instructions that, when executed by the one or more processors, cause the one or more processors to perform one or more elements of any one or more of the method 2100, the method 2500, the method 2800, and/or the method 3000. This apparatus may be, for example, an apparatus of a base station (such as a network device 3318 that is a base station, as described herein).

Embodiments contemplated herein include a signal as described in or related to one or more elements of any one or more of the method 2100, the method 2500, the method 2800, and/or the method 3000.

Embodiments contemplated herein include a computer program or computer program product comprising instructions, wherein execution of the program by a processing element is to cause the processing element to carry out one or more elements of any one or more of the method 2100, the method 2500, the method 2800, and/or the method 3000. The processor may be a processor of a base station (such as a processor(s) 3320 of a network device 3318 that is a base station, as described herein). These instructions may be, for example, located in the processor and/or on a memory of the base station (such as a memory 3322 of a network device 3318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
sending, to a network, a notification message identifying one or more reference signal time difference (RSTD)-based timing advance (TA) prediction models at the UE;
receiving, from the network, an activation message identifying a first RSTD-based TA prediction model for use from the one or more RSTD-based TA prediction models at the UE;
generating one or more actual RSTD-based TA measurements based on one or more reference signals received at the UE from one or more target cells of the network and a TA value for a serving cell of the network;
generating, using the first RSTD-based TA prediction model, one or more predicted RSTD-based TA measurements for a first target cell based on the one or more actual RSTD-based TA measurements for the one or more target cells; and
sending, to the network, an RSTD-based TA prediction report comprising the one or more predicted RSTD-based TA measurements.

2. The method of claim 1, wherein the one or more reference signals are reference signals of the first target cell.

3. The method of claim 1, wherein the one or more reference signals are reference signals that were not transmitted by the first target cell.

4. The method of claim 1, wherein the RSTD-based TA prediction report further includes a validity time for the one or more predicted RSTD-based TA measurements for the first target cell.

5. The method of claim 1, wherein the RSTD-based TA prediction report further includes a confidence level for the one or more predicted RSTD-based TA measurements for the first target cell.

6. The method of claim 1, further comprising:
receiving, from the network, configuration information indicating a predicted RSTD-based TA measurement periodicity and an actual RSTD-based TA measurement periodicity; and
sending an actual RSTD-based TA report comprising the one or more actual RSTD-based TA measurements for the first target cell to the UE according to the actual RSTD-based TA measurement periodicity;
wherein the RSTD-based TA prediction report comprising the one or more predicted RSTD-based TA measurements for the first target cell is sent according to the predicted RSTD-based TA measurement periodicity.

7. The method of claim 1, wherein the sending of the RSTD-based TA prediction report comprising the one or more predicted RSTD-based TA measurements to the network is triggered by a determination by the UE that a first predicted RSTD-based TA measurement of the one or more predicted RSTD-based TA measurements for the first target cell and a prior predicted RSTD-based TA measurement for the first target cell differ by at least threshold.

8. The method of claim 1, wherein the RSTD-based TA prediction report further comprises an indication that the one or more predicted RSTD-based TA measurements are predictive RSTD-based TA measurements.

9. (canceled)

10. The method of claim 1, wherein the one or more predicted RSTD-based TA measurements are sorted in the RSTD-based TA prediction report first based on Layer 3 (L3) measurements for corresponding cells, then based on confidence levels associated with the one or more predicted RSTD-based TA measurements.

11. A method of a radio access network (RAN), comprising:
receiving, from a user equipment (UE), a reference signal time difference (RSTD) timing advance (TA) prediction model;
sending, to the UE, one or more reference signals from one or more target cells;
receiving, from the UE, one or more actual RSTD-based TA measurements of the one or more reference signals; and
generating, using the RSTD-based TA prediction model, one or more predicted RSTD-based TA measurements for a first target cell based on the one or more actual RSTD-based TA measurements for the one or more target cells.

12. The method of claim 11, further comprising sending, to the UE, configuration information to be used by the UE to re-train the measurement prediction model.

13. The method of claim 11, further comprising receiving, from the UE, a timestamp at which the one or more actual RSTD-based TA measurements were generated.

14. The method of claim 11, further comprising receiving, from the UE, a position of the UE and a moving orientation of the UE.

15. The method of claim 11, further comprising receiving, from the UE, a change to a moving orientation of the UE.

16. A method of a user equipment (UE), comprising:
generating, using a reference signal time difference (RSTD) timing advance (TA) prediction model, one or more predicted RSTD-based TA measurements based on first reference signals received at the UE from one or more target cells of a network;
generating one or more actual RSTD-based TA measurements corresponding to the one or more predicted RSTD-based TA measurements by measuring second reference signals received at the UE from the one or more target cells;
calculating a confidence level using the one or more predicted RSTD-based TA measurements and the one or more actual RSTD-based TA measurements; and
reporting the confidence level to the network.

17. The method of claim 16, wherein the calculating the confidence level comprises determining a mean squared error (MSE) between the one or more predicted RSTD-based TA measurements and the one or more actual RSTD-based TA measurements.

18. The method of claim 16, further comprising receiving, from the network, an instructions to stop using the RSTD-based TA prediction model.

19. The method of claim 16, further comprising reporting, to the network, a first timestamp at which the one or more predicted RSTD-based TA measurements were generated and a second timestamp at which the one or more actual RSTD-based TA measurements were generated.

20. The method of claim 16, further comprising reporting, to the network, a position of the UE and a moving orientation of the UE.

21-31. (canceled)
